(19) United States
(12) Patent Application Publication
(10) Pub. No.: US 2016/0146727 A1
(43) Pub. Date: May 26, 2016

(54) METHODS AND SYSTEMS OF COMPUTATIONAL ANALYSIS FOR PREDICTING CHARACTERISTICS OF COMPOUND

(71) Applicant: Samsung Electronics Co., Ltd., Suwon-si (KR)

(72) Inventors: Yeong Suk CHOI, Suwon-si (KR); Dongseon LEE, Suwon-si (KR); lngyeong YOO, Yongin-si (KR); Kwonyoung KIM, Seoul (KR); Sungjin KIM, Suwon-si (KR); Tae-Rae KIM, Seoul (KR); Won-Joon SON, Yongin-si (KR)

(21) Appl. No.: 14/855,814

(22) Filed: Sep. 16, 2015

(30) Foreign Application Priority Data
Nov. 21, 2014 (KR) 10-2014-0163313

(51) Int. Cl. G01N 21/31; G01N 21/33

(52) U.S. Cl. CPC G01N 21/3103; G01N 21/33; G01N 2201/061

(57) ABSTRACT

A method for predicting characteristics of a compound includes collecting a first experimental information database for characteristics of reference compounds according to a quantum phenomenon, collecting a simulation database for characteristics of the reference compounds according to the quantum phenomenon by applying density functional theory methods, comparing the simulation database to the first experimental information database for each reference compound to calculate accuracy of the simulation database, clustering the reference compounds into clusters based on the accuracy of the simulation database and designating a proper density functional theory method for each cluster, comparing a similarity between a test compound to predict a characteristic according to the quantum phenomenon and the reference compounds included in each cluster, determining a proper density functional theory method for the test compound according to the similarity, and conducting a simulation with the test compound according to the determined density functional theory method.

### CROSS-REFERENCE TO RELATED APPLICATION

This application claims priority to and the benefit of Korean Patent Application No. 10-2014-016331 3 filed in the Korean Intellectual Property Office on Nov. 21, 2014, the entire contents of which are incorporated herein by reference.

### BACKGROUND

1. Field

Example embodiments relate to a method for predicting characteristics of compounds and systems.

2. Description of the Related Art

As a simulation method for predicting characteristics of a compound according to the quantum phenomenon, an Ab initio quantum chemistry method is used. The Ab initio quantum chemistry method is a computational chemical method based on quantum chemistry, which may be broadly classified into a Hartree-Fock method and a density functional theory-based method.

The Hartree-Fock method is a method of approximation for obtaining a wave function and energy of a many-body system in a stationary state, which is difficult to apply to a general compound because the calculation time is increased geometrically while the calculation accuracy is relatively high. The method based on the density functional theory is a method of substituting a wave function with an electron density function, which may be calculated faster than the Hartree-Fock method.

However, the method based on the density functional theory may provide different calculation results depending upon the kind of the applied density function, and it has a lack of intuitive basis to determine a proper method for increasing accuracy according to each compound.

### SUMMARY

Example embodiments provide a method of predicting characteristics of compounds with relatively high accuracy using a method based on the density functional theory.

Example embodiments also provide a system of predicting characteristics of compounds with relatively high accuracy using a method based on the density functional theory.

According to example embodiments, a method for predicting characteristics of a compound includes collecting a first experimental information database for characteristics of a plurality of reference compounds according to a quantum phenomenon, collecting a simulation database for characteristics of the plurality of reference compounds according to the quantum phenomenon by applying a plurality of density functional theory methods, comparing the simulation database to the first experimental information database for each reference compound of the plurality of reference compounds to calculate accuracy of the simulation database, clustering the plurality of reference compounds into a plurality of clusters based on the accuracy of the simulation database and designating a proper density functional theory method for each cluster of the plurality of clusters, comparing a similarity between a test compound to predict a characteristic according to the quantum phenomenon and the reference compounds included in each cluster of the plurality of clusters, determining a proper density functional theory method for the test compound according to the similarity, and conducting a simulation with the test compound according to the determined density functional theory method.

The characteristics according to the quantum phenomenon may be absorbance according to a wavelength of the plurality of reference compounds.

The characteristics according to the quantum phenomenon may be a full width at half maximum (FWHM) of a light absorption spectrum in a visible ray region.

The first experimental information database for the full width at half maximum (FWHM) may be measured by UV-Vis spectroscopy.

The experimental information of the full width at half maximum (FWHM) may be collected by preparing the plurality of reference compounds as a solution, and the plurality of reference compounds may have a full width at half maximum (FWHM) of about 40 nm to about 110 nm.

The plurality of density functional theory methods may include a first density functional theory method and a second density functional theory method, the cluster may include a first group of clusters having higher accuracy of the simulation database of the first density functional theory method and a second group of clusters having higher accuracy of the simulation database of the second density functional theory method, the plurality of reference compounds included in the first group of clusters may have a full width at half maximum (FWHM) of about 40 nm to about 110 nm when applying the first density functional theory method, and the plurality of reference compounds included in the second group of clusters may have a full width at half maximum (FWHM) of about 40 nm to about 110 nm when applying the second density functional theory method.

The compound included in the first group of clusters may have an arylamine moiety substituted with at least two aryl groups.

The simulation database may have an accuracy of greater than or equal to about 80%.

The similarity between the test compound and the plurality of reference compounds included in each cluster of the plurality of clusters may include a structural similarity of a compound.

Prior to clustering the plurality of reference compounds into a plurality of clusters based on the accuracy of the simulation database and designating a proper density functional theory method for each cluster of the plurality of clusters, the method may further include clustering the plurality of reference compounds according to a structural similarity after comparing the simulation database to the first experimental information database for each reference compound of the plurality of reference compounds.

The method may further include separating a reference compound that does not cluster from the plurality of reference compounds after comparing the simulation database to the first experimental information database for each reference compound of the plurality of reference compounds.

The method may further include collecting a second experimental information database by conducting an experiment for the test compound and updating the test compound to the plurality of reference compounds using the second experimental information database.

The plurality of reference compounds and the test compound may be one of p-type and n-type light-absorbing materials.

According to example embodiments, a system of predicting characteristics of a compound includes using the method of example embodiments.

According to example embodiments, a system for predicting a characteristic of a compound includes a non-transitory computer readable medium having a computer program logic embodied thereon, the computer program logic configured to collect a simulation database for characteristics of a plurality of reference compounds according to a quantum phenomenon by applying an experimental information database for characteristics of the plurality of reference compounds according to the quantum phenomenon and a plurality of density functional theory methods, calculate accuracy of the simulation database by comparing the experimental information database to the simulation database, cluster the plurality of reference compounds based on the accuracy of the simulation database and designating a proper density functional theory method for each cluster, compare a similarity between the test compound and the reference compounds included in each cluster to predict the characteristics according to the quantum phenomenon, determine a proper density functional theory method for the test compound according to the similarity, and conduct a simulation of the test compound according to the determined density functional theory method.

The characteristics according to the quantum phenomenon may include a full width at half maximum (FWHM) of a light absorption spectrum in a visible ray region.

The plurality of density functional theory methods may include a first density functional method and a second density functional theory method, the cluster may include a first group of clusters having higher accuracy of the simulation database of the first density functional theory method and a second group of clusters having higher accuracy of the simulation database of the second density functional theory method, the plurality of reference compounds included in the first group of clusters may have a full width at half maximum (FWHM) of about 40 nm to about 110 nm when applying the first density functional theory method, and the plurality of reference compounds included in the second group may have a full width at half maximum (FWHM) of about 40 nm to about 110 nm when applying the second density functional theory method.

### BRIEF DESCRIPTION OF THE DRAWINGS

FIG. 1 is a flowchart sequentially showing a method for predicting characteristics of a compound according to example embodiments,

FIG. 2 is a flowchart sequentially showing a method for predicting characteristics of a compound according to example embodiments,

FIG. 3 is a flowchart sequentially showing a method for predicting characteristics of a compound according to example embodiments,

FIG. 4 is a flowchart sequentially showing a method for predicting characteristics of a compound according to example embodiments, and

FIG. 5A to 17C are graphs showing light absorption spectrums obtained from UV-Vis spectroscopy of compound 1 and compounds 2 to 14, light absorption spectrums when simulated using DFT1, and light absorption spectrums when simulated using DFT2.

### DETAILED DESCRIPTION

Example embodiments will hereinafter be described in detail, and may be more easily performed by those who have common knowledge in the related art. This disclosure may, however, be embodied in many different forms, and should not be construed as limited to the example embodiments set forth herein.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third, fourth etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present inventive concepts.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the present inventive concepts. As used herein, the singular forms “a,” “an” and “the” are intended to include the plural forms as well, unless the context clearly indicates otherwise. It will be further understood that the terms “comprises”, “includes”, “including” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized example embodiments (and intermediate structures). As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present inventive concepts.

In the following description, illustrative embodiments may be described with reference to acts and symbolic representations of operations (e.g., in the form of flow charts, flow diagrams, data flow diagrams, structure diagrams, block diagrams, etc.) that may be implemented as program modules or functional processes including routines, programs, objects, components, data structures, etc., that perform particular tasks or implement particular abstract data types. The operations may be implemented using existing hardware in existing memory devices or systems. Such existing hardware may include one or more Central Processing Units (CPUs), digital signal processors (DSPs), application-specific-integrated-circuits (ASICs), system-on-chips (SoCs), field programmable gate arrays (FPGAs), computers, or the like.

Further, one or more example embodiments may be (or include) hardware, firmware, hardware executing software, or any combination thereof. Such hardware may include one or more CPUs, SoCs, DSPs, ASICs, FPGAs, computers, or the like, configured as special purpose machines to perform the functions described herein as well as any other well-known functions of these elements. In at least some cases, CPUs, SoCs, DSPs, ASICs and FPGAs may generally be referred to as processing circuits, processors and/or microprocessors.

Although a flow chart may describe operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

As disclosed herein, the term “storage medium”, “computer readable storage medium” or “non-transitory computer readable storage medium,” may represent one or more devices for storing data, including read only memory (ROM), random access memory (RAM), magnetic RAM, core memory, magnetic disk storage mediums, optical storage mediums, flash memory devices and/or other tangible machine readable mediums for storing information. The term “computer-readable medium” may include, but is not limited to, portable or fixed storage devices, optical storage devices, and various other mediums capable of storing, containing or carrying instruction(s) and/or data.

Furthermore, at least some portions of example embodiments may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a computer readable storage medium. When implemented in software, processor(s), processing circuit(s), or processing unit(s) may be programmed to perform the necessary tasks, thereby being transformed into special purpose processor(s) or computer(s).

A code segment may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters or memory contents. Information, arguments, parameters, data, etc. may be passed, forwarded, or transmitted via any suitable means including memory sharing, message passing, token passing, network transmission, etc.

Unless otherwise defined, all terms (including technical and scientific terms) used herein have the same meaning as commonly understood by one of ordinary skill in the art to which the inventive concepts belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

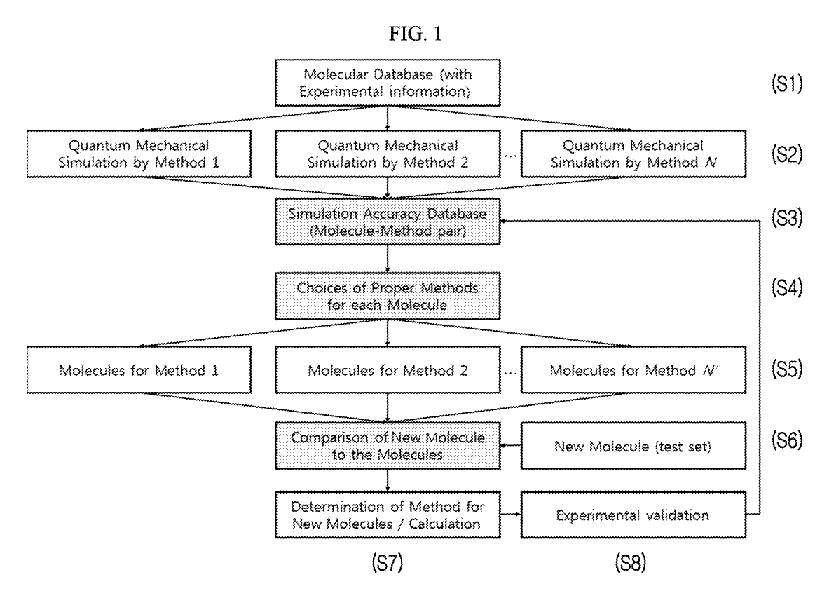

Hereinafter, referring to FIG. 1, a method for predicting characteristics of a compound according to example embodiments is described.

FIG. 1 is a flowchart sequentially showing a method for predicting characteristics of a compound according to example embodiments.

Referring to FIG. 1, a method for predicting characteristics of a compound according to example embodiments includes collecting an experimental information database for characteristics of a plurality of reference compounds according to a quantum phenomenon (hereinafter referred to as “characteristics”) [S1], collecting a simulation database for characteristics of the plurality of reference compounds by applying a plurality of density functional theory (DFT) methods [S2], comparing the simulation database of each reference compound to the experimental information database and calculating accuracy of the simulation database [S3], clustering the plurality of reference compounds based on the accuracy of the simulation database and designating a proper density functional theory method for each cluster [S4], comparing a similarity between the test compound to predict characteristics and the reference compounds included in the cluster [S5], determining a proper density functional theory method for the test compound according to the similarity [S6], and performing a simulation in accordance with the determined density functional theory method for the test compound [S7].

The compound is not particularly limited, but may include, for example, all of organic compounds, inorganic compounds, organic/inorganic compounds, monomers, oligomers, and/or polymers. For example, the compound may be a light-absorbing material having light absorptive characteristics.

The characteristic according to the quantum phenomenon, which is an inherent characteristic of compounds, may be various. For example, it may be absorbance according to a wavelength of a compound, for example, a full width at half maximum (FWHM) of the light absorption spectrum in a visible ray region. Herein, the FWHM is a width of a wavelength corresponding to half of a maximum absorption point, and a small FWHM indicates selective absorption of light in a relatively narrow wavelength region and relatively high wavelength selectivity, while a relatively large FWHM indicates broad absorption of light in a relatively wide wavelength region and relatively low wavelength selectivity.

The step S1 of collecting an experimental information database for characteristics of a plurality of reference compounds includes selecting the reference compounds having specific experiment information and making a database for experimental information for characteristics of the reference compounds. For example, when the characteristic is a full width at half maximum (FWHM) of a light absorption spectrum in a visible ray region, the reference compounds having experimental information of a full width at half maximum (FWHM) measured by UV-Vis spectroscopy are selected, and the experimental data of the full width at half maximum (FWHM) of the reference compounds may be organized in a database.

For example, the experimental information of the full width at half maximum (FWHM) may be obtained by dissolving the reference compounds in a solvent to prepare a solution, and measuring light absorption characteristics of the solution. For example, the reference compounds may be dissolved in a solvent, e.g., toluene, in a predetermined or given concentration of, for example, about 1.0×10-5 mol/L to prepare a solution and measured. For example, the reference compounds may have a full width at half maximum (FWHM) of about 40 nm to about 110 nm.

The step S2 of collecting the simulation database is a step including applying the plurality of reference compounds with a plurality of density functional theory (DFT) methods (Method 1, Method 2, . . . , Method N) and simulating the same. The plurality of density functional theory (DFT) methods may include, for example, B3LYP (Becke, three-parameter, Lee-Yang-Parr), PBE0, HSE (Heyd-Scuseria-Ernzerhof), M06, M06-L, M06-2X, M06-HF, M11, SOGGA11X, N12SX, MN12SX, or BMK, but is not limited thereto. For example, when the characteristic is a full width at half maximum (FWHM) of light absorption spectrum in a visible ray region, a light absorption spectrum simulation may be carried out by applying a plurality of density functional theory (DFT) methods (Method 1, Method 2, . . . , Method N).

The step S3 of calculating accuracy of the simulation database is a step of comparing the experimental information database of each reference compound to the simulation database and calculating how near the experimental information is when the experimental information is 100%.

Subsequently, the plurality of reference compounds may be clustered based on the accuracy. For example, when a first method, a second method, . . . , an Nth method are used as the plurality of density functional theory (DFT) methods, the reference compounds may be clustered as follows: the reference compounds having the highest accuracy in the first method are collected among the plurality of reference compounds and designated as a first group; the reference compounds having the highest accuracy in the second method are collected among the plurality of reference compounds and designated as a second group; and the reference compounds having the highest accuracy in the Nth method are collected among the plurality of reference compounds and designated as a Nth group.

The each group clustered as above is designated to a proper density functional theory method for each group [S4]. Through the selecting a density functional theory method desirable for the reference compounds in each group, the proper density functional theory method for the each group may be determined. When the accuracy of the various density functional theory methods is higher than the reference during the selection, multiple choices may be possible, and when any density functional theory method is not satisfied with the accuracy standard, it may be clustered but may be excluded from the selection process. The accuracy may be relative, but may be, for example, greater than or equal to about 80%. Thereby, the first group may be designated by the first method, the second group may be designated by the second method, and the Nth group may be designated by the Nth method.

Subsequently, the similarity between the test compound to predict the characteristics thereof and the reference compounds is compared [S5]. The similarity may include a structural similarity of the compound, but is not limited thereto. The structural similarity of the compound may include, for example, a moiety similarity, a main backbone similarity, or a functional group similarity.

The test compound is determined to go with which group according to the similarity, and the proper density functional theory method thereof is determined [S6]. For example, based on the compound structure described by molecular fingerprint, a Tanimoto coefficient is established as a similarity standard, and the density functional theory method of the group including the most similar compound in the database may be determined.

Subsequently, the test compound may be carried out with a simulation according to the determined density functional theory method [S7].

Like this, using the simulation database applied with the experimental information database for the characteristics of the reference compounds and the various density functional theory methods, the reference compounds are clustered, and the similarity between the test compound to predict the characteristics and the clustered reference compounds is compared, so that the proper density functional theory method may be more easily determined.

Accordingly, the method of example embodiments may compensate for the relatively low average prediction accuracy and the relatively high standard deviation of the prediction accuracy when generally predicting the characteristics of the test compound, and the trial and error method of searching for the proper density functional theory method for the test compound may be reduced. In addition, the method of example embodiments may compensate for the incompleteness caused by the approximation applied to the simulation.

Meanwhile, the method of example embodiments may further include performing an experiment for the test compound to collect an additional experimental information database and updating the test compound to the reference compound using the additional experimental information database [S8]. The repeating updates may increase the number of reference compounds, so as to contribute to further enhancement of the accuracy.

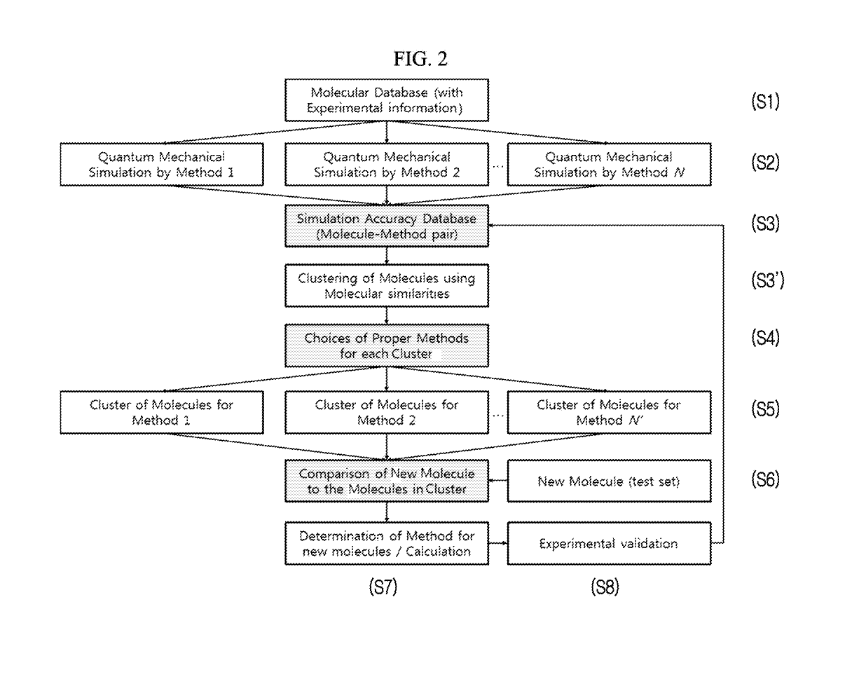

Hereinafter, a method for predicting characteristics of a compound according to example embodiments is described with reference to FIG. 2.

FIG. 2 is a flowchart sequentially showing a method for predicting characteristics of a compound according to example embodiments.

Referring to FIG. 2, a method for predicting characteristics of a compound according to example embodiments includes, as in the example embodiment illustrated in FIG. 1, collecting an experimental information database for characteristics of a plurality of reference compounds [S1], collecting a simulation database for characteristics of the plurality of reference compounds by applying a plurality of density functional theory (DFT) methods [S2], comparing the simulation database of each reference compound to the experimental information database and calculating accuracy of the simulation database [S3], clustering the plurality of reference compounds based on the accuracy of the simulation database and designating a proper density functional theory method for each cluster [S4], comparing a similarity between the test compound to predict characteristics and the reference compounds included in each cluster [S5], determining a proper density functional theory method for the test compound according to the similarity [S6], and performing a simulation in accordance with the determined density functional theory method for the test compound [S7].

However, unlike the method according to the example embodiment illustrated in FIG. 2, the method for predicting characteristics of a compound may further include comparing the structural similarity of the reference compounds and clustering the same (S3′) regardless of the accuracy of the simulation database between the calculating the accuracy of the simulation database and the designating a proper density functional theory method for each cluster. For example, the algorithm of determining a similarity using a Tanimoto coefficient based on the compound structure described by a molecular fingerprint and of clustering the same may apply hierarchical clustering.

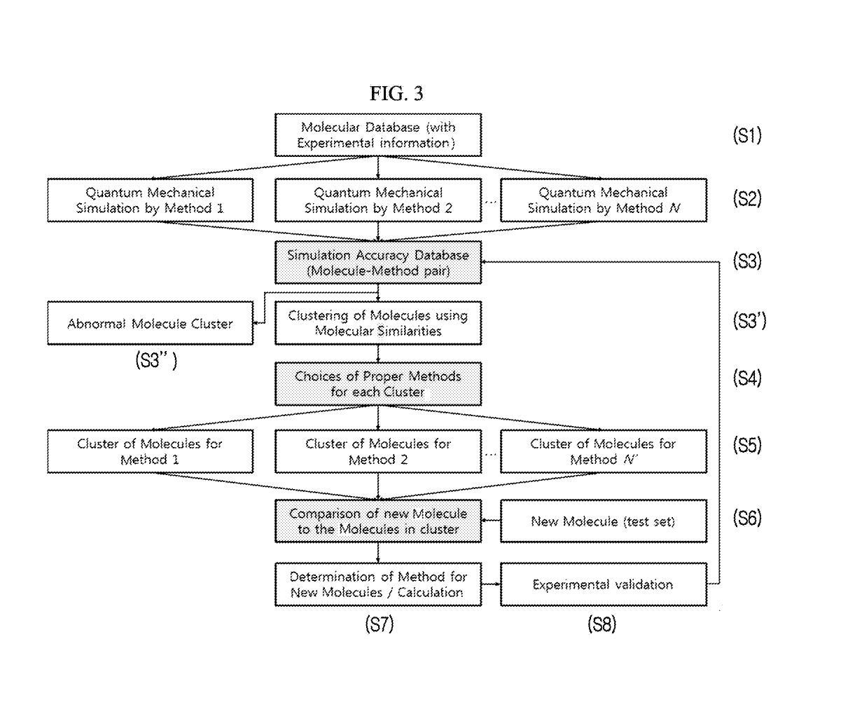

Hereinafter a method for predicting characteristics of a compound according to example embodiments is described with reference to FIG. 3.

FIG. 3 is a flowchart sequentially showing a method for predicting characteristics of a compound according to example embodiments.

Referring to FIG. 3, as in the example embodiment illustrated in FIG. 2, a method for predicting characteristics of a compound according to example embodiments includes collecting an experimental information database for characteristics of a plurality of reference compounds [S1], collecting a simulation database for characteristics of the plurality of reference compounds by applying a plurality of density functional theory (DFT) methods [S2], comparing the simulation database of each reference compound to the experimental information database and calculating accuracy of the simulation database [S3], clustering the plurality of reference compounds based on the accuracy of the simulation database and designating a proper density functional theory method for each cluster [S4], comparing a similarity between the test compound to predict characteristics and the reference compounds included in each cluster [S5], determining a proper density functional theory method for the test compound according to the similarity [S6], and performing a simulation in accordance with the determined density functional theory method for the test compound [S7].

However, unlike the example embodiment illustrated in FIG. 2, the method for predicting characteristics of a compound according to example embodiments may further include separating a compound which does not cluster (S3″) after calculating an accuracy of the simulation database. This is a step of separating and removing the reference compounds of which it is difficult to predict the characteristics (hereinafter, referred to as ‘abnormal reference compounds’) according to any density functional theory method.

After separating and removing the abnormal reference compound, it may preliminarily determine whether the conducting a simulation by directly comparing the test compound to the abnormal reference compound is suitable.

In addition, after separating and removing the abnormal reference compound, the abnormal reference compound is clustered in one cluster, and then the causes of the abnormal reference compound are searched through comparing the characteristics between the cluster and the other clusters including the normal reference compounds. Thereby, it may determine whether a simulation may be carried out through comparing with the test molecule.

Accordingly, the appropriateness of prediction model application may be preliminarily determined, so the result may be reliability enhanced, and the calculation time may be reduced.

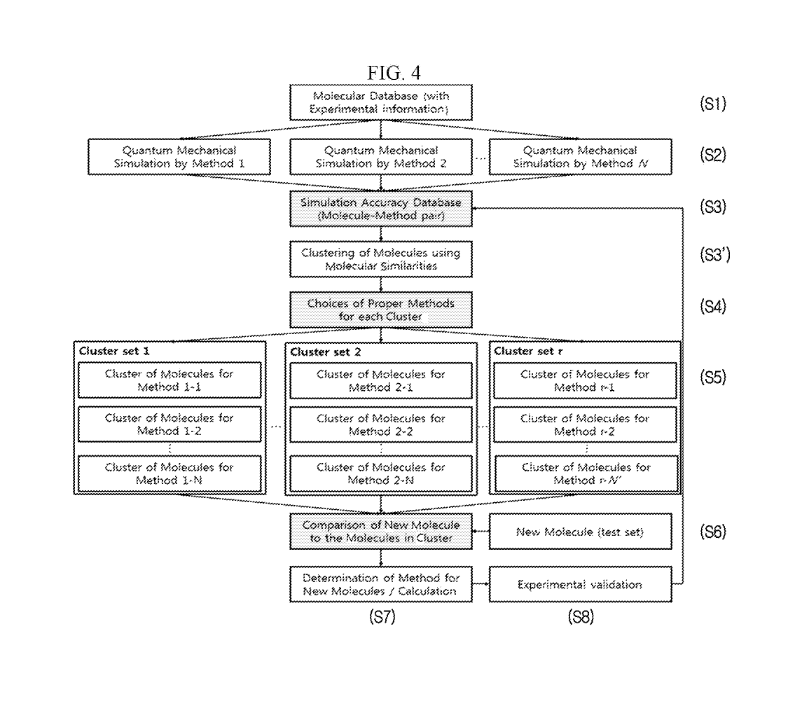

Hereinafter, a method for predicting characteristics of a compound according to example embodiments is described with reference to FIG. 4.

FIG. 4 is a flowchart sequentially showing a method for predicting characteristics of a compound according to example embodiments.

Referring to FIG. 4, like the example embodiment illustrated in FIG. 3, a method for predicting characteristics of a compound includes collecting an experimental information database for characteristics of a plurality of reference compounds [S1], collecting a simulation database for characteristics of the plurality of reference compounds by applying a plurality of density functional theory (DFT) methods [S2], comparing the simulation database of each reference compound to the experimental information database and calculating accuracy of the simulation database [S3], clustering the plurality of reference compounds based on the accuracy of the simulation database and designating a proper density functional theory method for each cluster [S4], comparing a similarity between the test compound to predict characteristics and the reference compounds included in each cluster [S5], determining a proper density functional theory method for the test compound according to the similarity [S6], and performing a simulation in accordance with the determined density functional theory method for the test compound [S7].

However, unlike the example embodiment illustrated in FIG. 3, according to the method for predicting characteristics of a compound according to example embodiments, it may determine the density functional theory method for the test compound after providing a plurality (r) of sub-clusters and comparing each sub-cluster when the clustering method is non-deterministic, e.g., k-means clustering.

Hereinafter, a system of predicting characteristics of a compound according to example embodiments is described.

The system of predicting the characteristics of a compound according to example embodiments may be performed by the above methods, specifically, includes a medium having a computer program logic for predicting characteristics of a compound, wherein the computer program logic includes: a function of calling a simulation database for characteristics of the plurality of reference compounds by applying an experimental information database for characteristics of a plurality of reference compounds and a plurality of density functional theory methods; a function of calculating accuracy of the simulation database by comparing the experimental information database to the simulation database; a function of clustering the plurality of reference compounds based on the accuracy of the simulation database and designating a proper density functional theory method for each cluster; a function of comparing a similarity between a test compound to predict characteristics and the reference compounds included in each cluster; a function of determining a proper density functional theory method for the test compound according the similarity; and a function of performing a simulation in accordance with the determined density functional theory method for the test compound.

The system may be used for predicting characteristics of a compound, and for example, the characteristics may be absorbance according to a wavelength, for example, a FWHM of the light absorption spectrum in a visible ray region.

For example, when the system is used to predict a full width at half maximum (FWHM) of the light absorption spectrum in a visible ray region, the system may be used to choose a light-absorbing material having relatively high wavelength selectivity for a device required for the wavelength selectivity, e.g., an organic photoelectric device.

For example, in the organic photoelectric device including a first electrode and a second electrode facing each other and an active layer disposed between the first electrode and the second electrode and including a light-absorbing material, the light-absorbing material may include a compound to be predicted to have a full width at half maximum (FWHM) of about 40 nm to 110 nm using the system.

For example, the organic photoelectric device may be applied to an image sensor.

Hereinafter, the present disclosure is illustrated in more detail with reference to examples. However, these are examples, and the present disclosure is not limited thereto.

### Synthesis of Reference Compound

### Synthesis Example 1

The Compound 1 is synthesized according to Reaction Scheme 1.

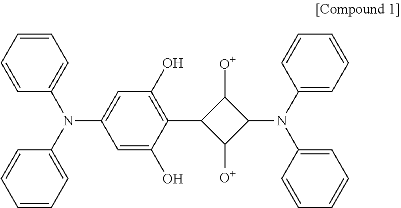 [SMILES: Oc1cc(N(c2ccccc2)c2ccccc2)cc(O)c1C1C([OH2+])C(N(c2ccccc2)c2ccccc2)C1[OH2+]]

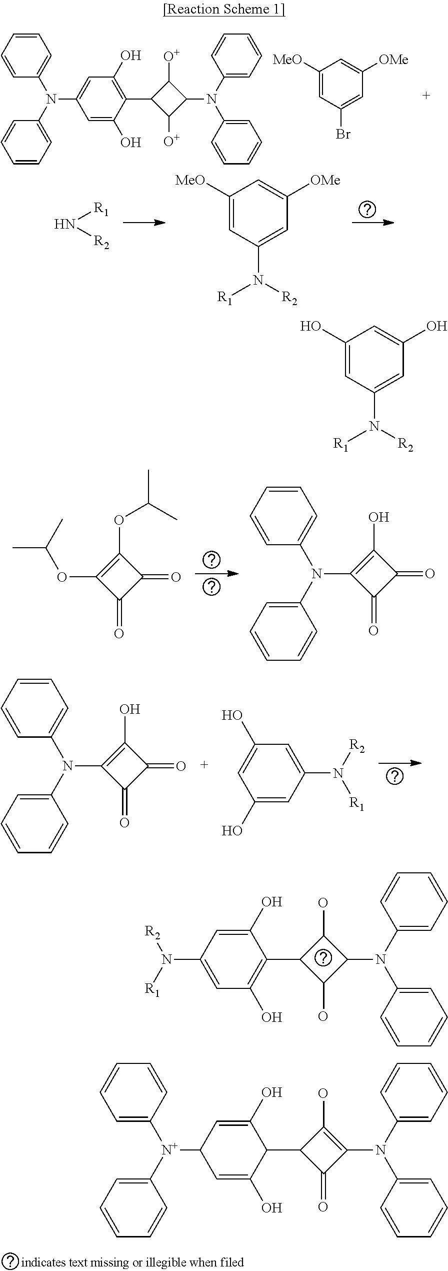

### Synthesis Example 2

The Compound 2 is synthesized according to Reaction Scheme 2.

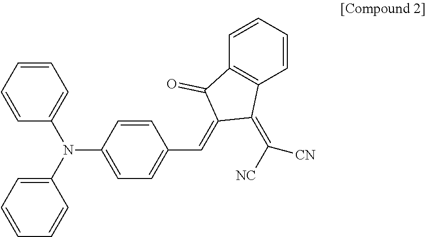 [SMILES: N#CC(C#N)=C1/C(=C/c2ccc(N(c3ccccc3)c3ccccc3)cc2)C(=O)c2ccccc21]

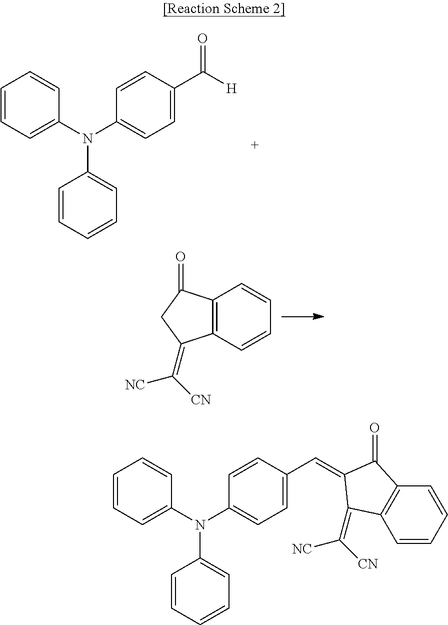 [SMILES: O=Cc1ccc(N(c2ccccc2)c2ccccc2)cc1 ; N#CC(C#N)=C1CC(=O)c2ccccc21 ; N#CC(C#N)=C1/C(=C\c2ccc(N(c3ccccc3)c3ccccc3)cc2)C(=O)c2ccccc21]

### Synthesis Example 3

The Compound 3 is synthesized according to Reaction Scheme 3.

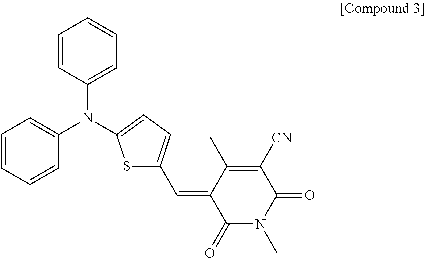 [SMILES: CC1=C(C#N)C(=O)N(C)C(=O)/C1=C/c1ccc(N(c2ccccc2)c2ccccc2)s1]

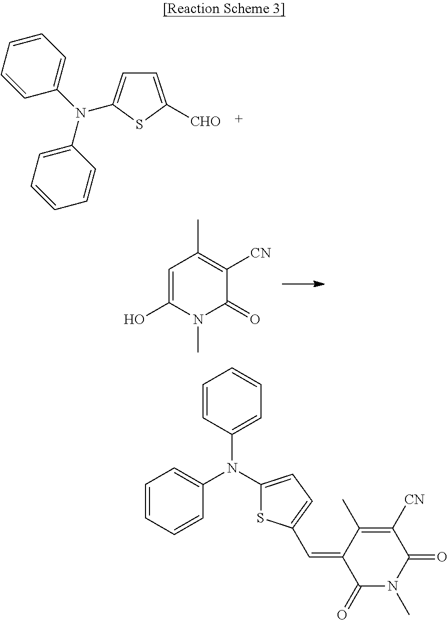

### Synthesis Example 4

The Compound 4 is synthesized according to Reaction Scheme 4.

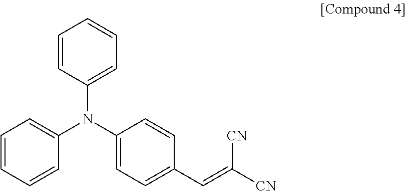 [SMILES: N#CC(C#N)=Cc1ccc(N(c2ccccc2)c2ccccc2)cc1]

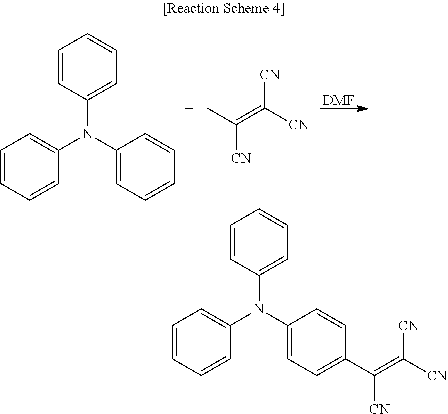

### Synthesis Example 5

The Compound 5 is synthesized according to Reaction Scheme 5.

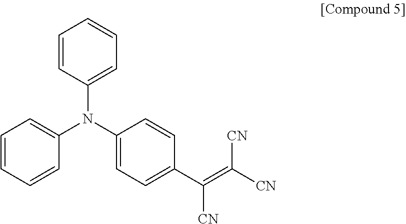 [SMILES: N#CC(C#N)=C(C#N)c1ccc(N(c2ccccc2)c2ccccc2)cc1]

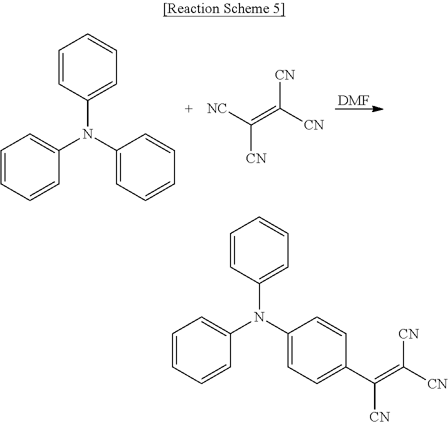

### Synthesis Example 6

The Compound 6 is synthesized according to Reaction Scheme 6.

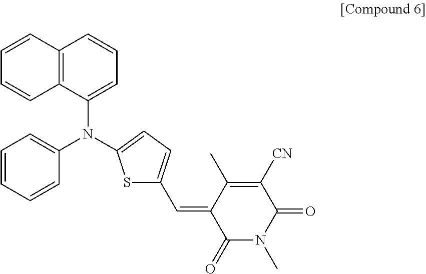 [SMILES: CC1=C(C#N)C(=O)N(C)C(=O)/C1=C/c1ccc(N(c2ccccc2)c2cccc3ccccc23)s1]

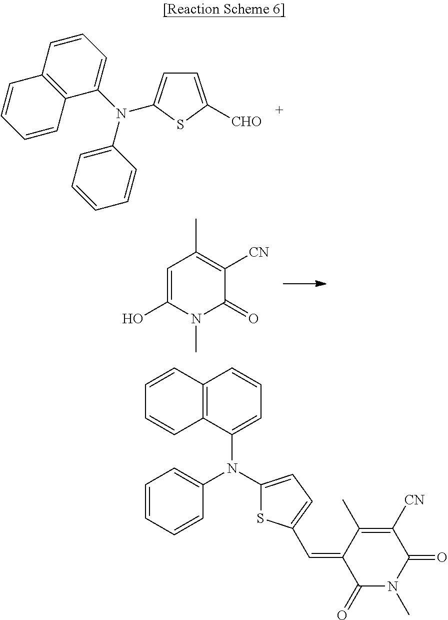

### Synthesis Example 7

The Compound 7 is synthesized according to Reaction Scheme 7.

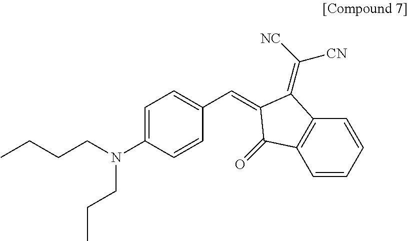 [SMILES: CCCCN(CCC)c1ccc(/C=C2\C(=O)c3ccccc3C2=C(C#N)C#N)cc1]

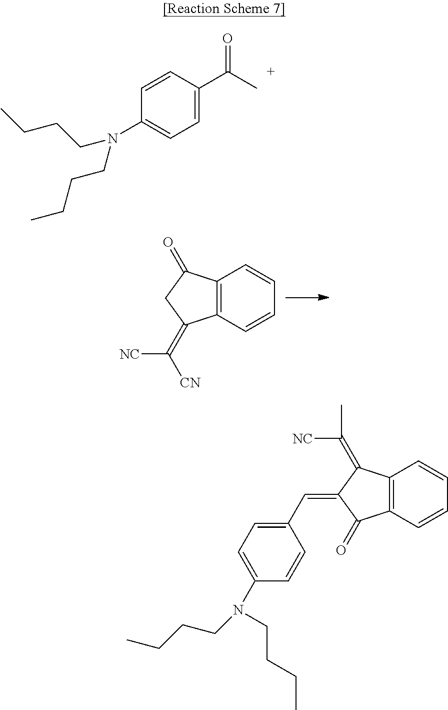 [SMILES: CCCCN(CCCC)c1ccc(C(C)=O)cc1 ; N#CC(C#N)=C1CC(=O)c2ccccc21 ; CCCCN(CCCC)c1ccc(/C=C2\C(=O)c3ccccc3\C2=C(/C)C#N)cc1]

### Synthesis Example 8

The Compound 8 is synthesized according to Reaction Scheme 8.

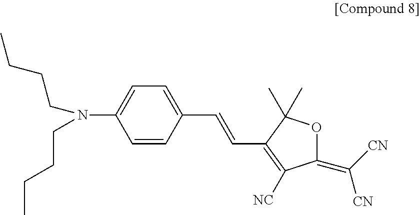 [SMILES: CCCCN(CCCC)c1ccc(/C=C/C2=C(C#N)C(=C(C#N)C#N)OC2(C)C)cc1]

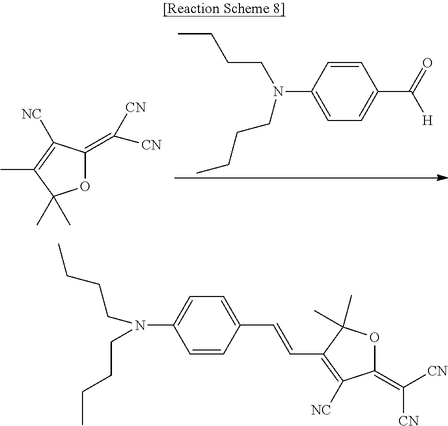

### Synthesis Example 9

The Compound 9 is synthesized according to Reaction Scheme 9.

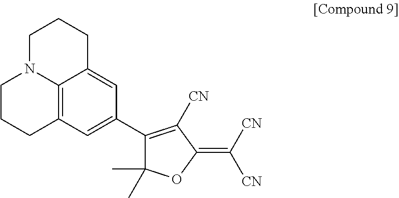 [SMILES: CC1(C)OC(=C(C#N)C#N)C(C#N)=C1c1cc2c3c(c1)CCCN3CCC2]

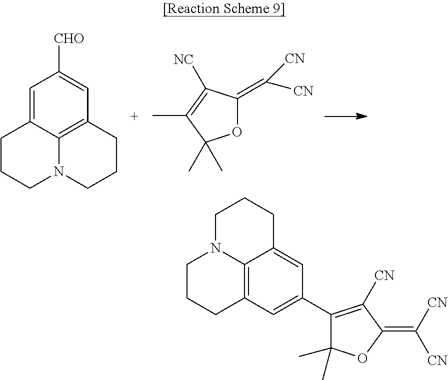

### Synthesis Example 10

The Compound 10 is synthesized according to Reaction Scheme 10.

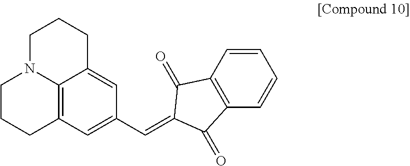 [SMILES: O=C1C(=Cc2cc3c4c(c2)CCCN4CCC3)C(=O)c2ccccc21]

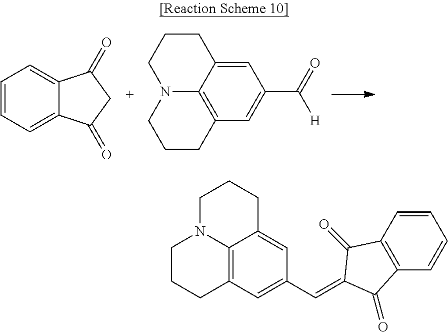

### Synthesis Example 11

The Compound 11 is synthesized according to Reaction Scheme 11.

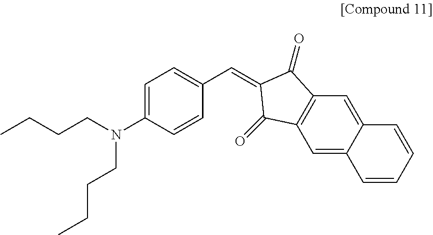 [SMILES: CCCCN(CCCC)c1ccc(C=C2C(=O)c3cc4ccccc4cc3C2=O)cc1]

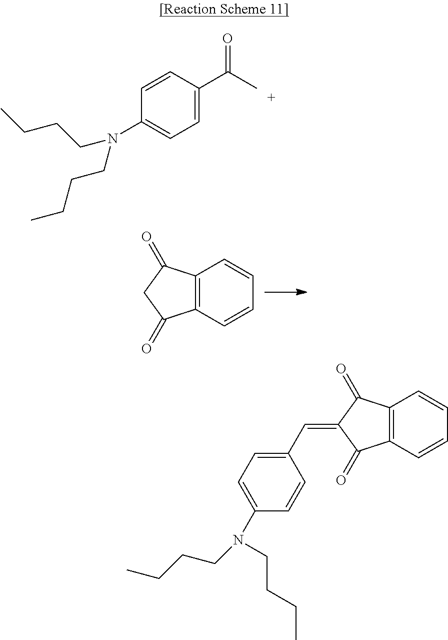 [SMILES: CCCCN(CCCC)c1ccc(C(C)=O)cc1 ; O=C1CC(=O)c2ccccc21 ; CCCCN(CCCC)c1ccc(C=C2C(=O)c3ccccc3C2=O)cc1]

### Synthesis Example 12

The Compound 12 is synthesized according to Reaction Scheme 12.

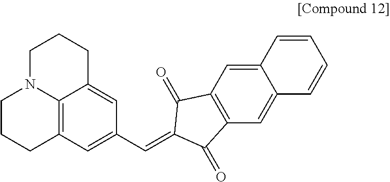 [SMILES: O=C1C(=Cc2cc3c4c(c2)CCCN4CCC3)C(=O)c2cc3ccccc3cc21]

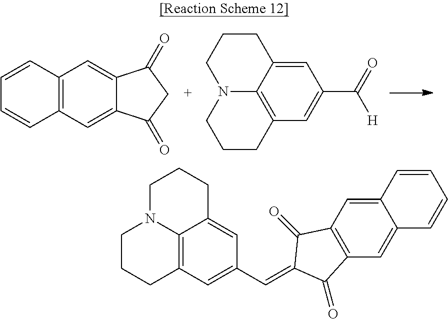

### Synthesis Example 13

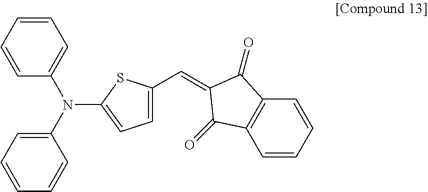 [SMILES: O=C1C(=Cc2ccc(N(c3ccccc3)c3ccccc3)s2)C(=O)c2ccccc21]

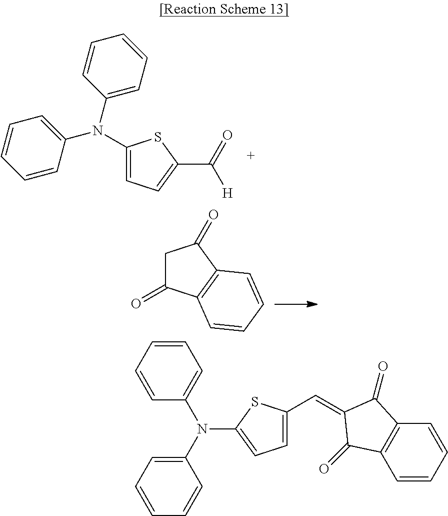

### Synthesis Example 14

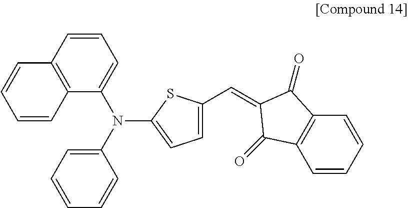 [SMILES: O=C1C(=Cc2ccc(N(c3ccccc3)c3cccc4ccccc34)s2)C(=O)c2ccccc21]

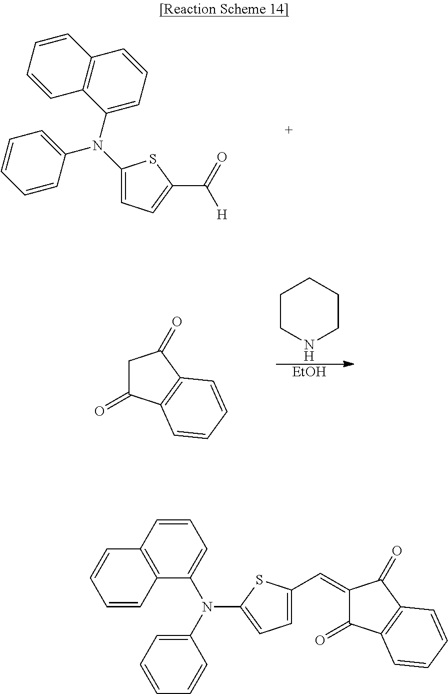 [SMILES: "EtOH" ; O=Cc1ccc(N(c2ccccc2)c2cccc3ccccc23)s1 ; O=C1CC(=O)c2ccccc21 ; C1CCNCC1 ; O=C1C(=Cc2ccc(N(c3ccccc3)c3cccc4ccccc34)s2)C(=O)c2ccccc21]

### Experimental Evaluation of Full Width at Half Maximum (FWHM)

The Compounds 1 to 14 obtained from Synthesis Examples 1 to 14 are measured for a full width at half maximum (FWHM) of light absorption spectrum in a visible ray region.

The light absorption characteristics are measured in a state of a solution, and the compounds obtained from Synthesis Examples 1 to 14 are each dissolved in toluene at 1.0×10⁻⁵ mol/L and irradiated with ultraviolet (UV)-visible ray (UV-Vis) using a Cary 5000 UV spectroscopy (manufactured by Varian) and evaluated.

The results are shown in Table 1.

TABLE 1

| | FWHM (nm) |
|---|---|
| | (Experimental values) |
| Compound 1 | 60 |
| Compound 2 | 87 |
| Compound 3 | 53 |
| Compound 4 | 61 |
| Compound 5 | 84 |
| Compound 6 | 47 |
| Compound 7 | 73 |
| Compound 8 | 88 |
| Compound 9 | 67 |
| Compound 10 | 48 |
| Compound 11 | 49 |
| Compound 12 | 51 |
| Compound 13 | 51 |
| Compound 14 | 47 |

Referring to Table 1, it is confirmed that the Compounds 1 to 14 have full widths at half maximum (FWHM) ranging from about 40 nm to about 110 nm. As a reference, the full width at half maximum (FWHM) of a film is estimated to be about 2 times the full width at half maximum (FWHM) of a solution.

### Simulation Evaluation of Full Width at Half Maximum (FWHM)

The Compounds 1 to 14 are simulated for a full width at half maximum (FWHM) of the light absorption spectrum in a visible ray region using two kinds of density functional theory methods (DFT). One is B3LYP, which is referred to as DFT1. The other is M11, which is referred to as DFT2.

The results are shown in Table 2.

TABLE 2

| | DFT1 | | DFT2 | |
|---|---|---|---|---|
| | | Error from the | | Error from the |
| | FWHM | experimental | FWHM | experimental |
| | (nm) | values | (nm) | values |
| Compound 1 | 52.2 | 7.8 | 43.5 | 16.5 |
| Compound 2 | 97.0 | 10.0 | 64.6 | 22.4 |
| Compound 3 | 53.1 | 0.1 | 72.9 | 19.9 |
| Compound 4 | 60.3 | 0.7 | 47.3 | 13.7 |
| Compound 5 | 78.4 | 5.6 | 55.5 | 28.5 |
| Compound 6 | 55.2 | 8.2 | 69.1 | 22.1 |
| Compound 7 | 132.5 | 59.5 | 63.3 | 9.7 |
| Compound 8 | 45.9 | 42.1 | 75.4 | 12.6 |
| Compound 9 | 40.1 | 26.9 | 59.2 | 7.8 |
| Compound 10 | 39.1 | 8.9 | 48.6 | 0.6 |
| Compound 11 | 45.8 | 3.2 | 51.4 | 2.4 |
| Compound 12 | 47.1 | 3.9 | 51.4 | 0.4 |
| Compound 13 | 48.3 | 2.7 | 55.8 | 4.8 |
| Compound 14 | 46.2 | 0.8 | 47.8 | 0.8 |

### Accuracy Calculation of Simulation

Referring to Tables 1 and 2, the accuracy of the simulation is calculated.

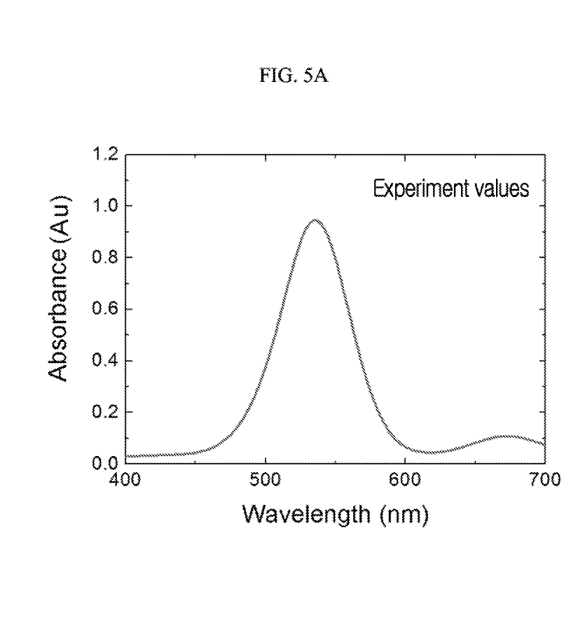

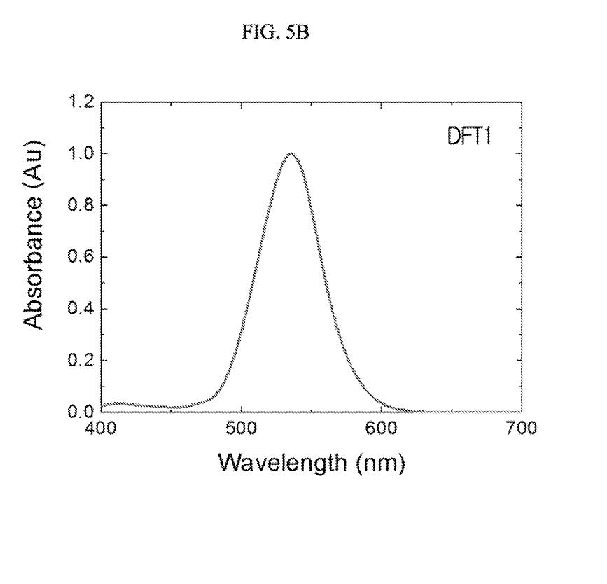

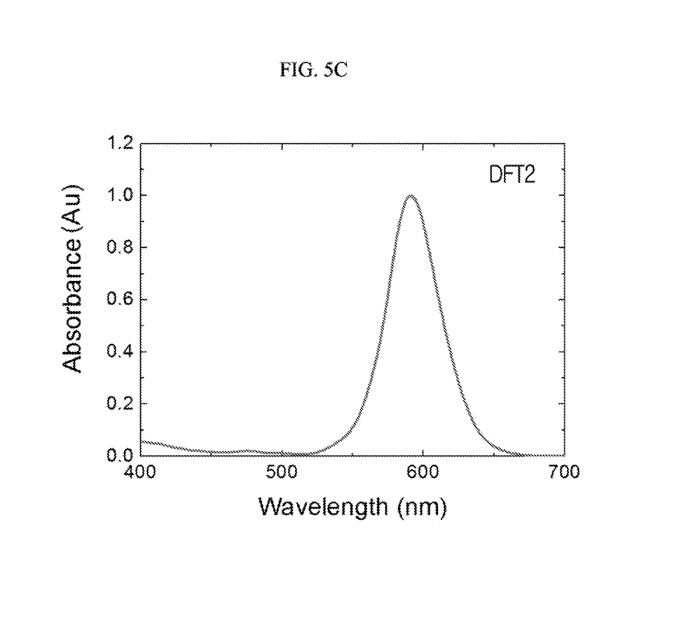

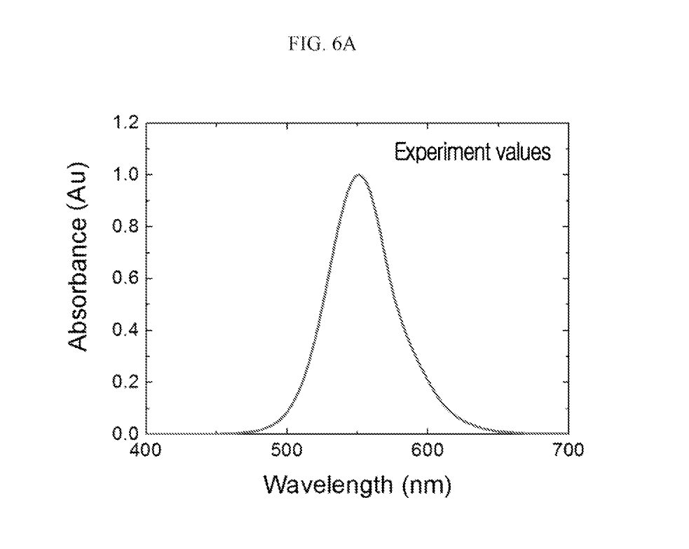

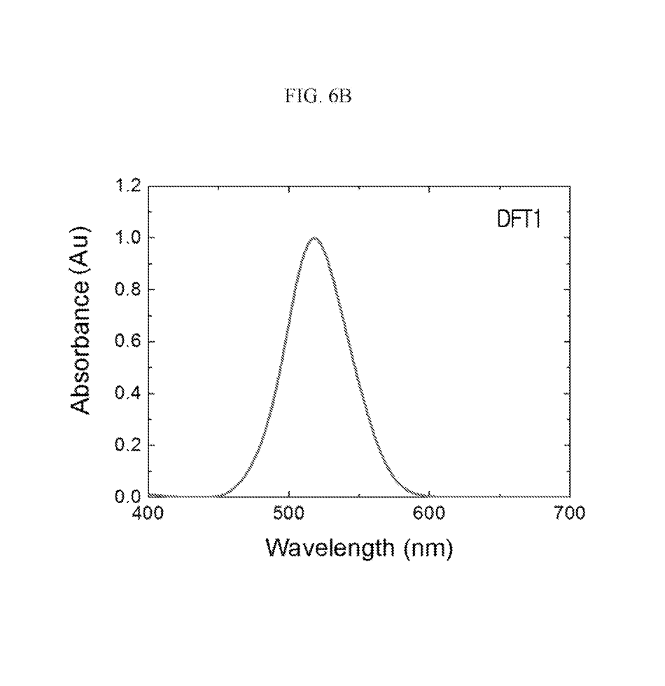

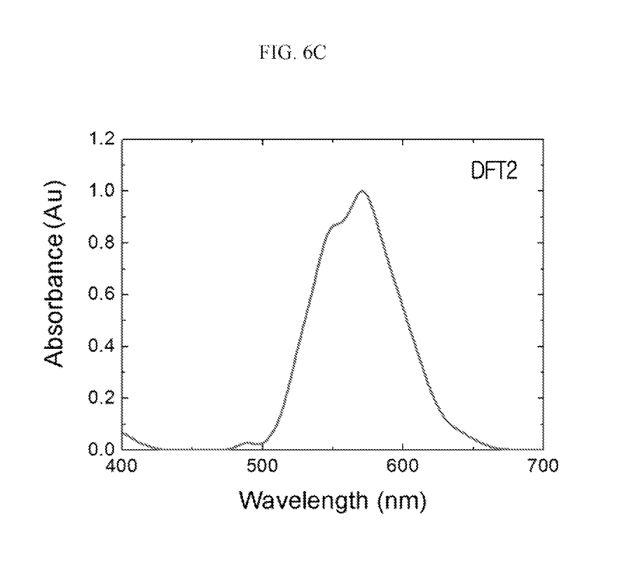

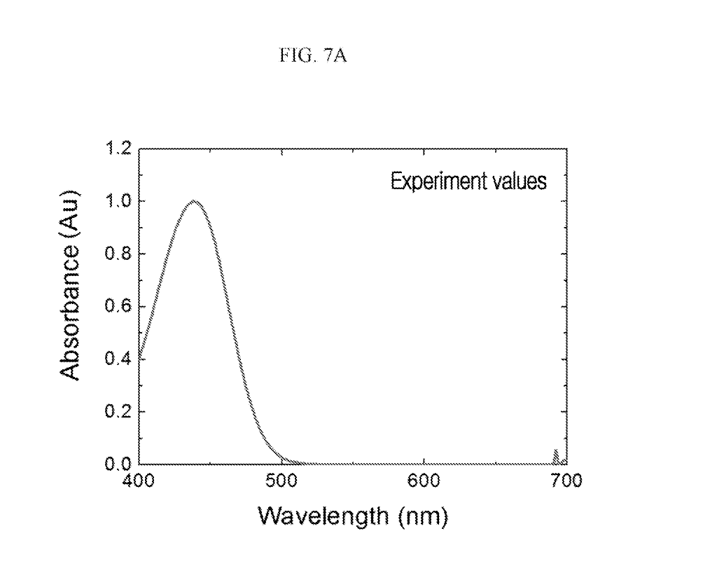

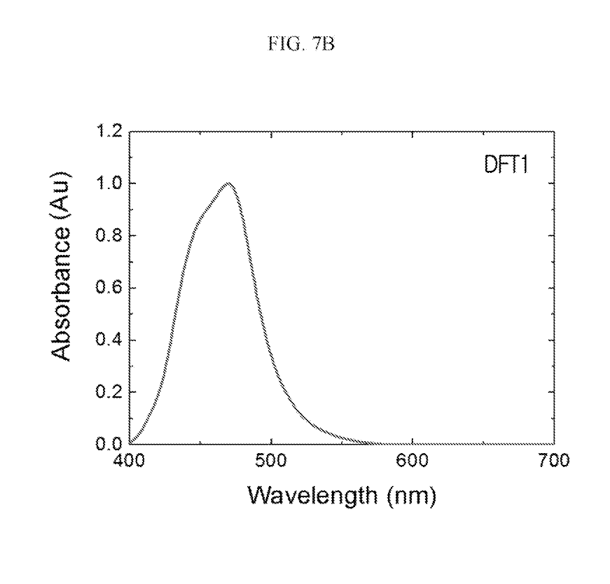

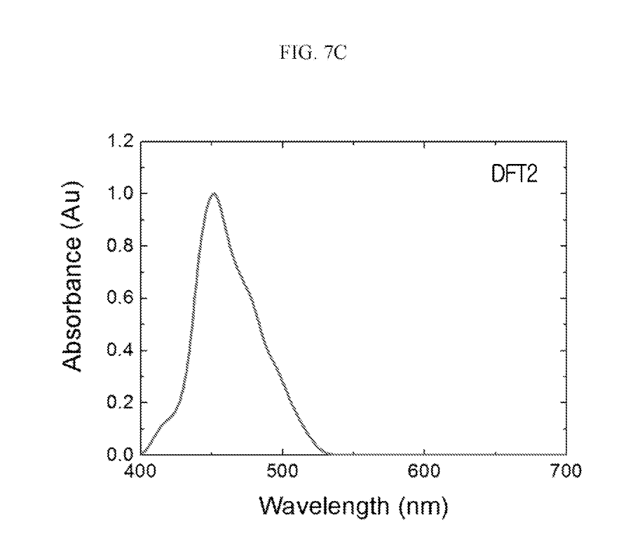

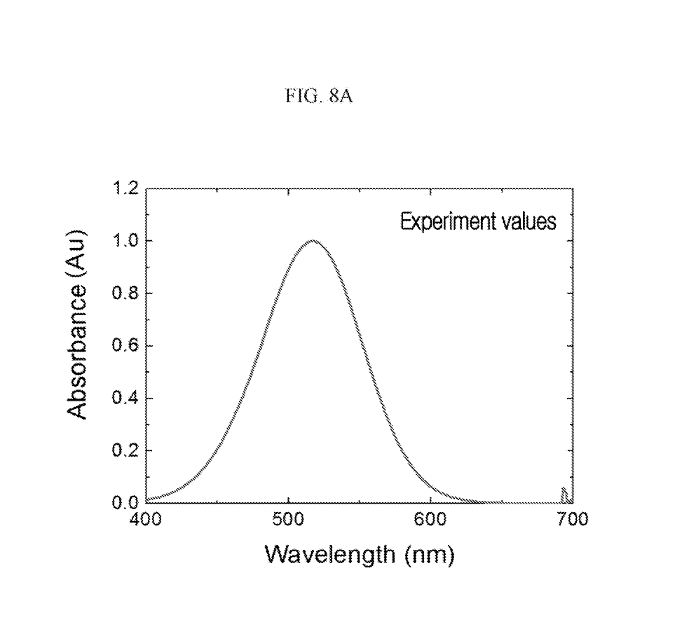

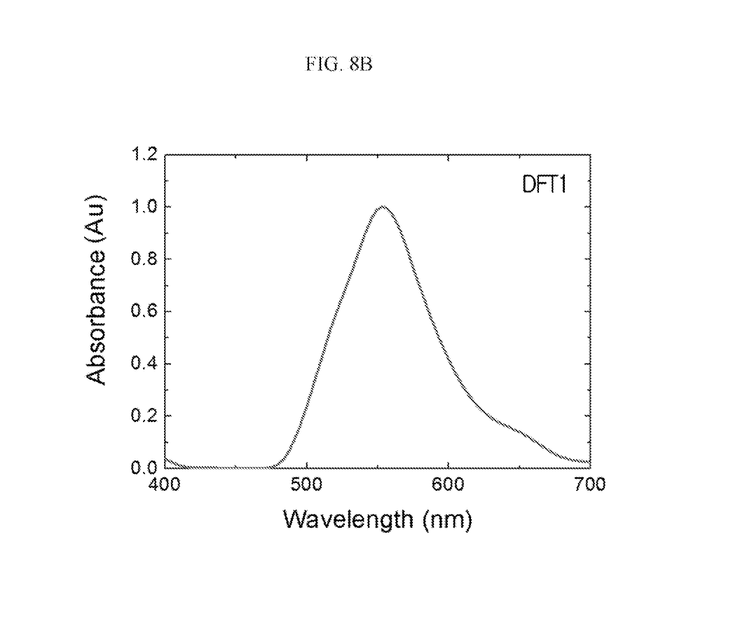

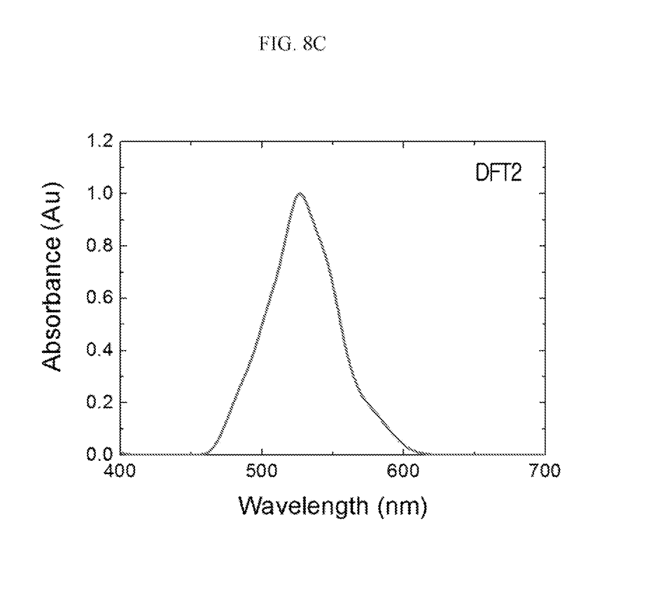

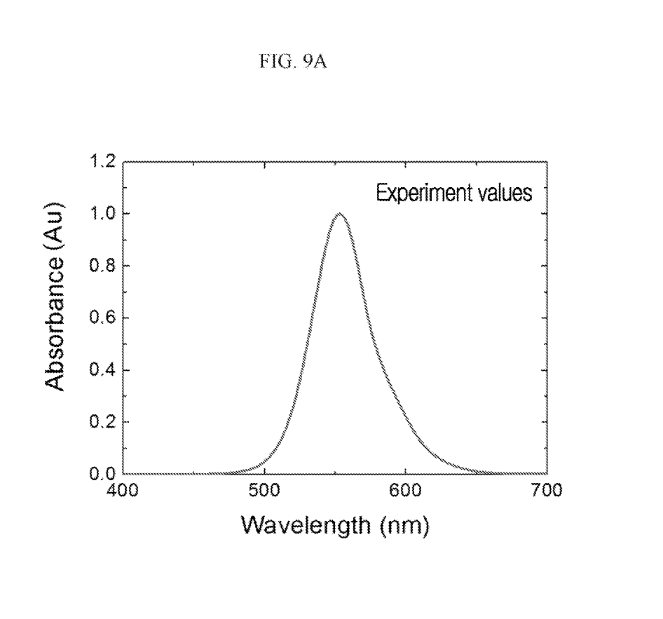

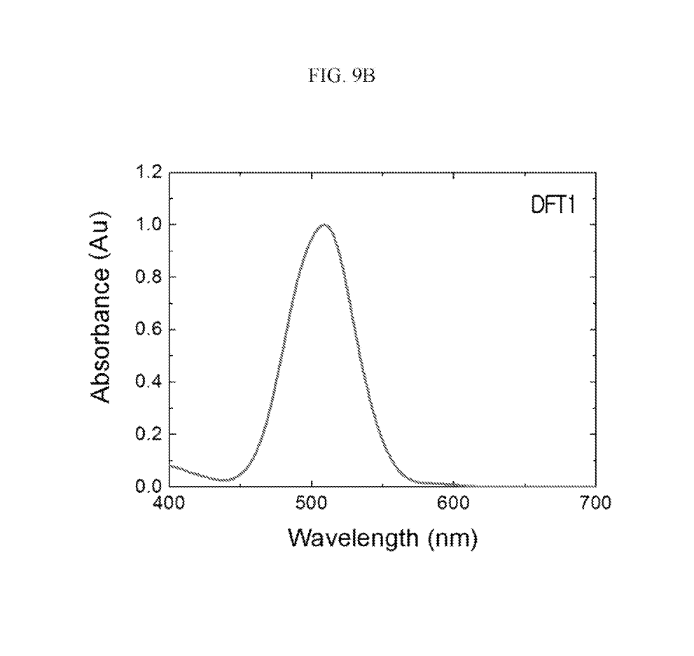

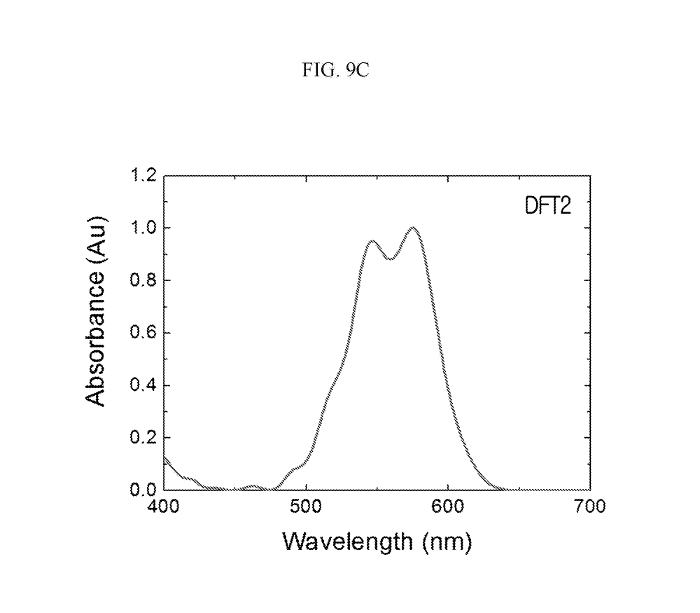

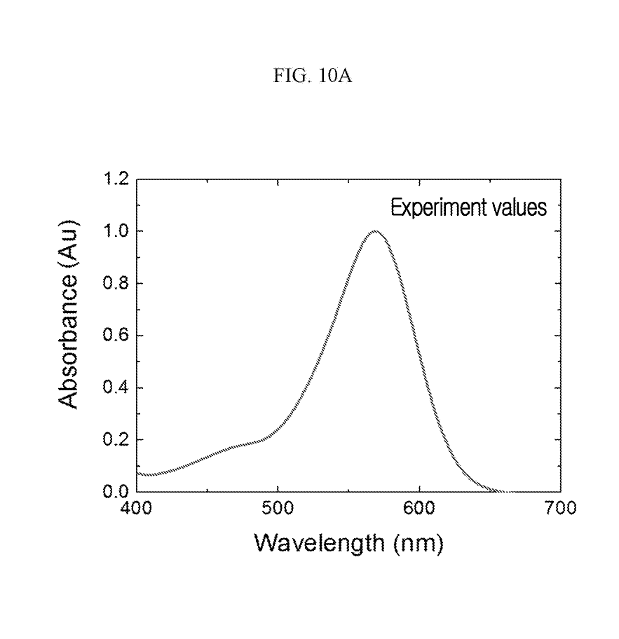

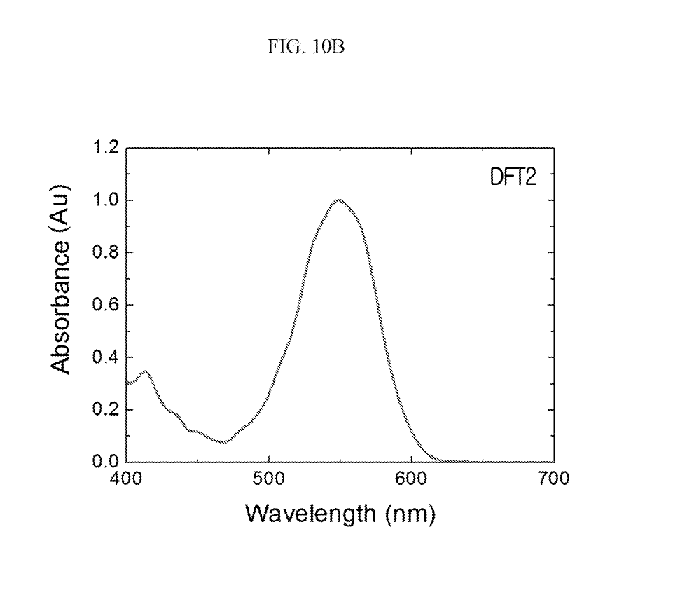

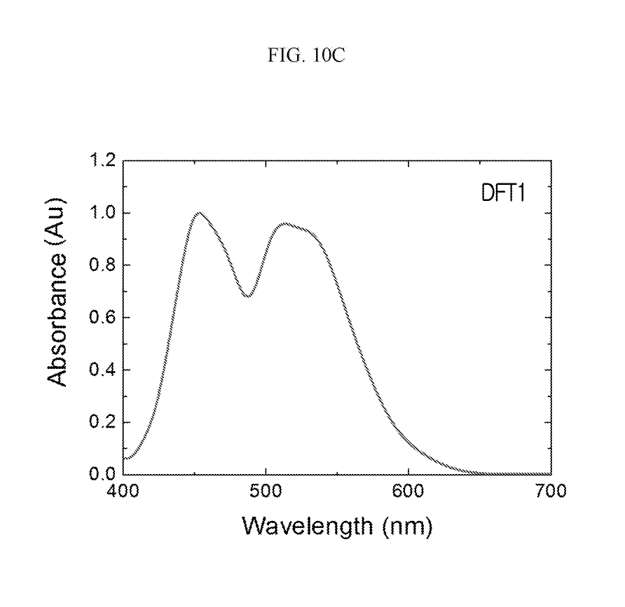

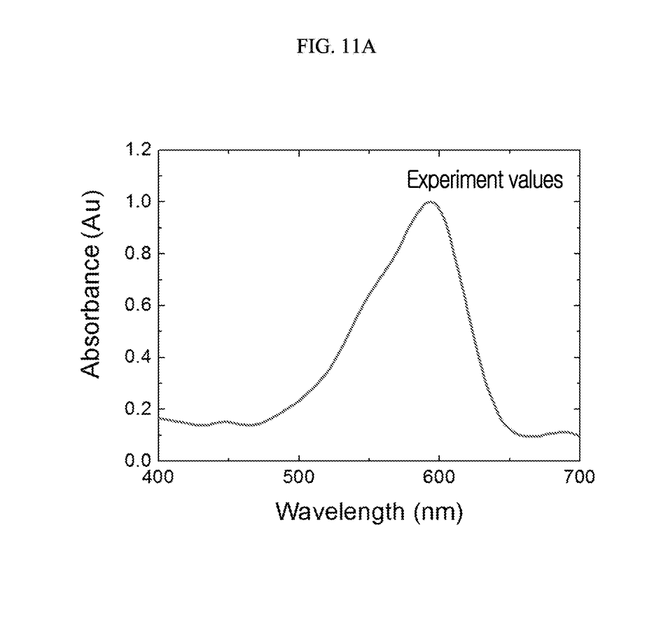

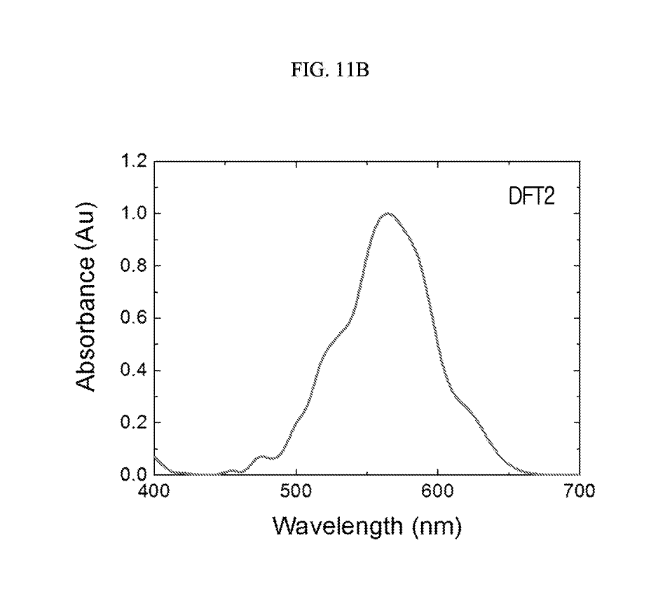

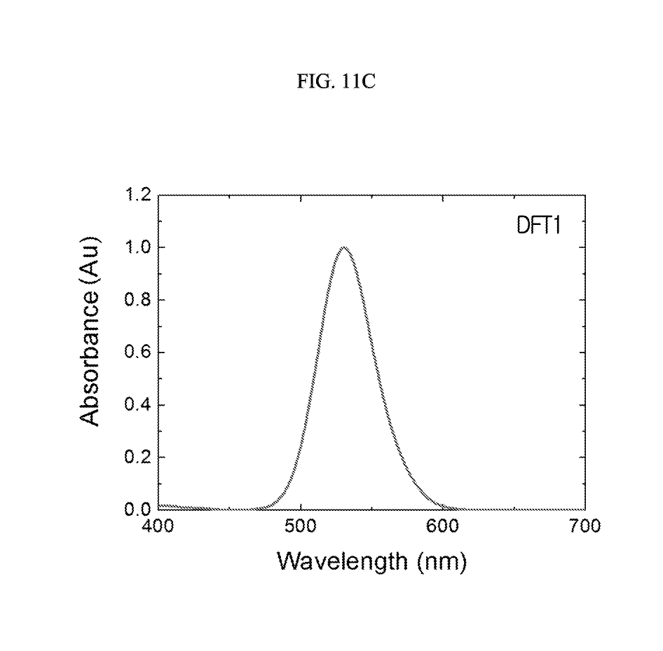

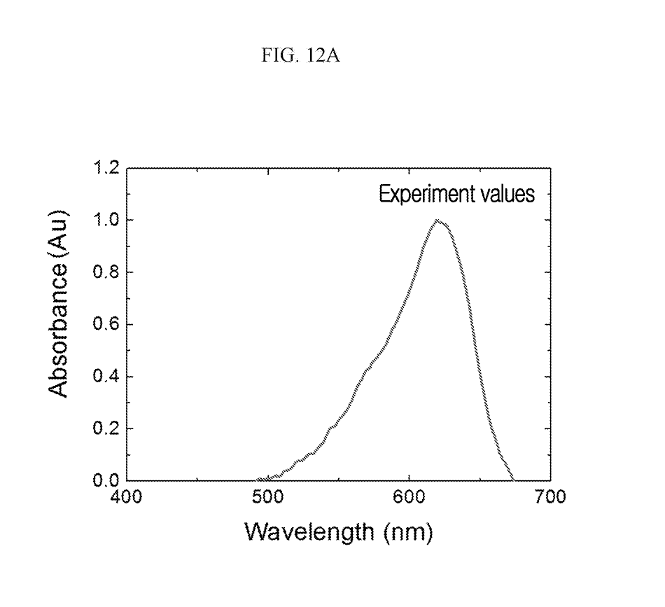

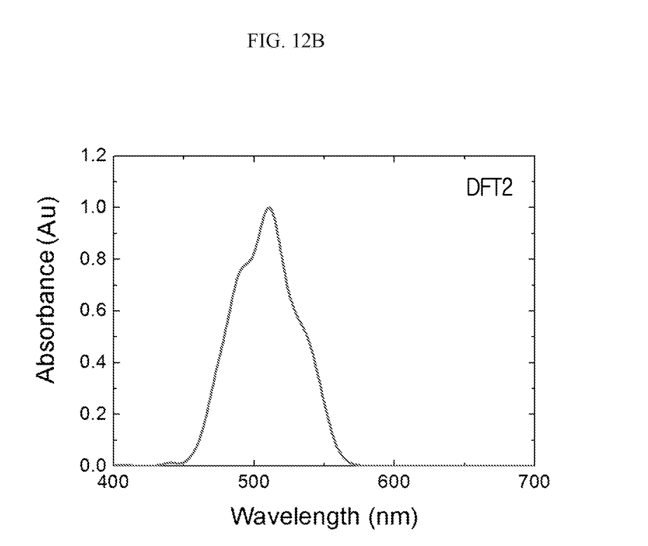

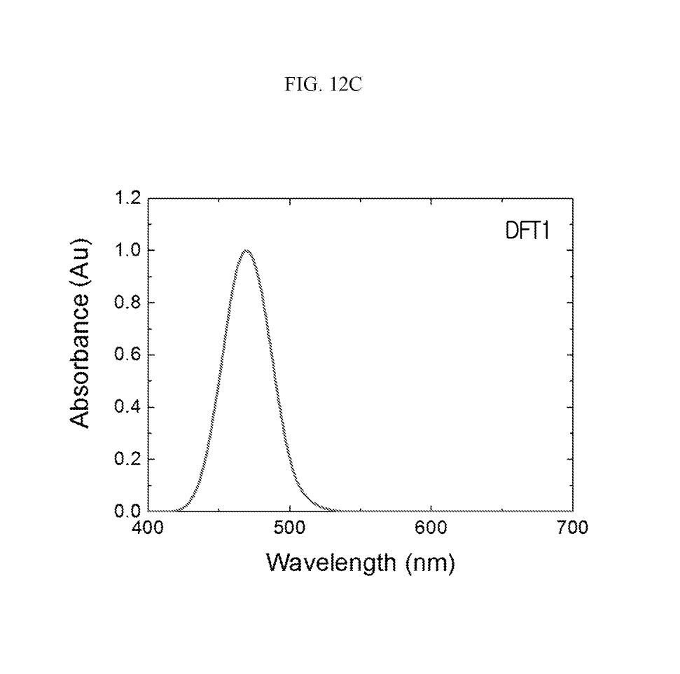

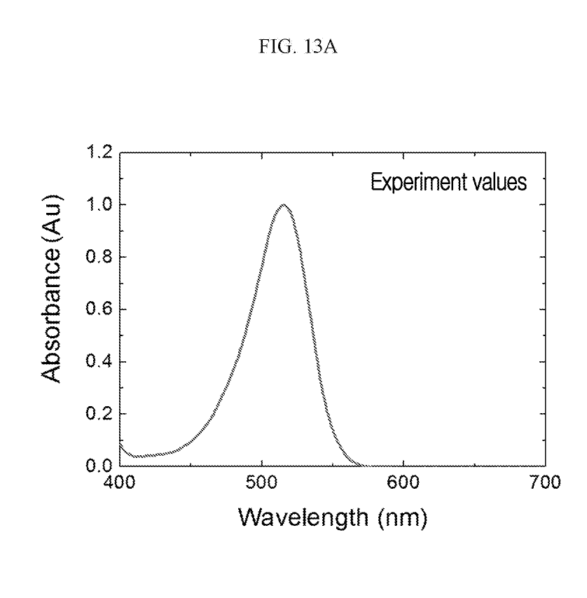

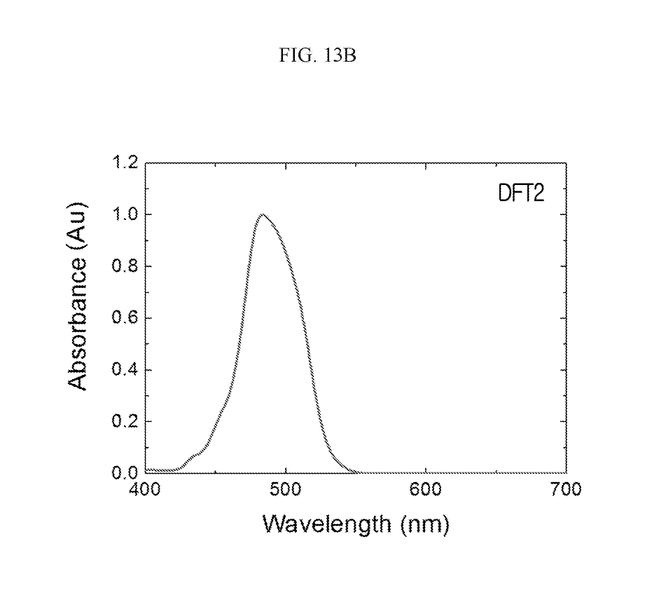

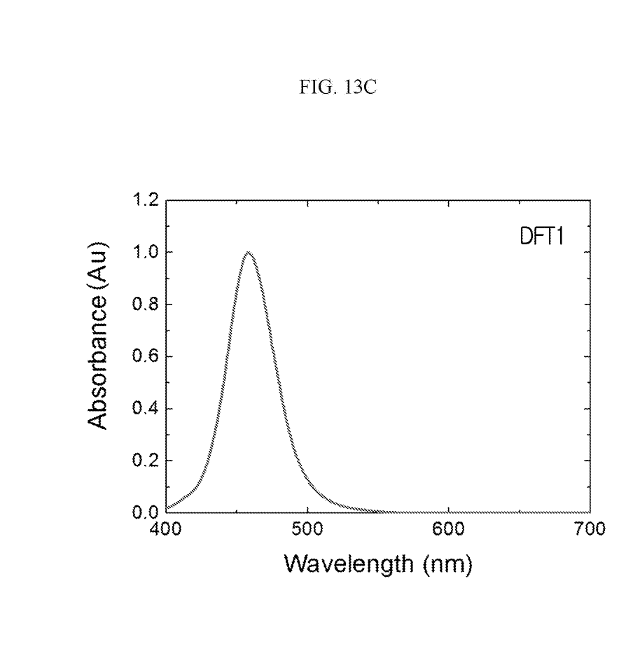

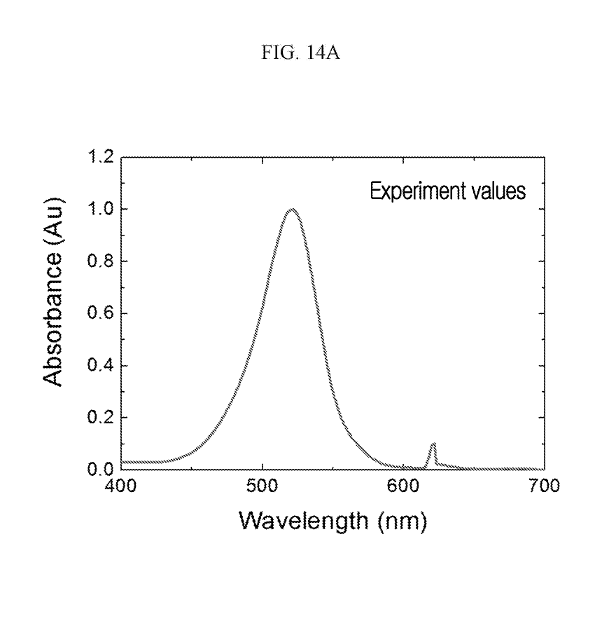

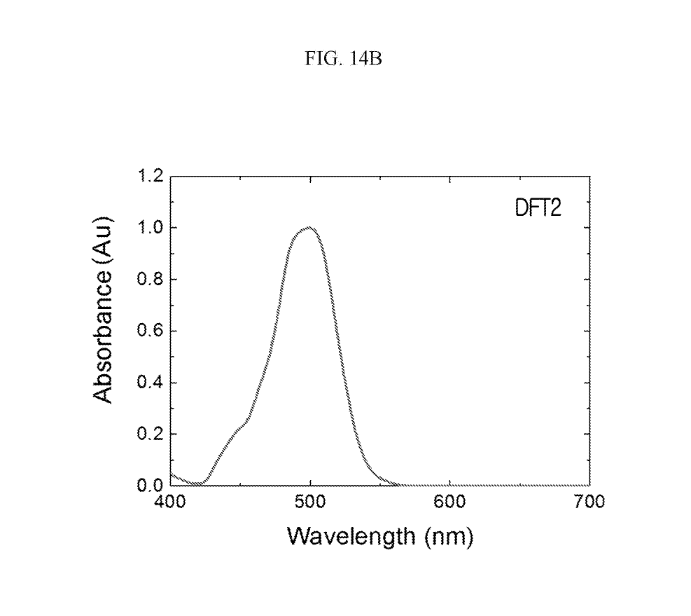

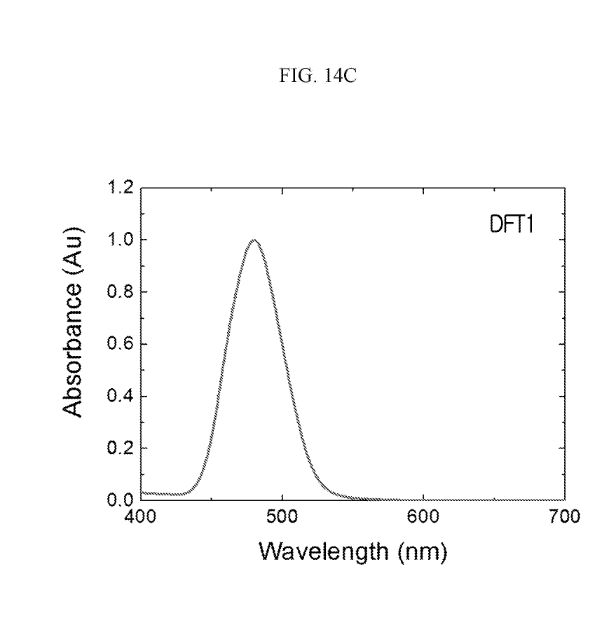

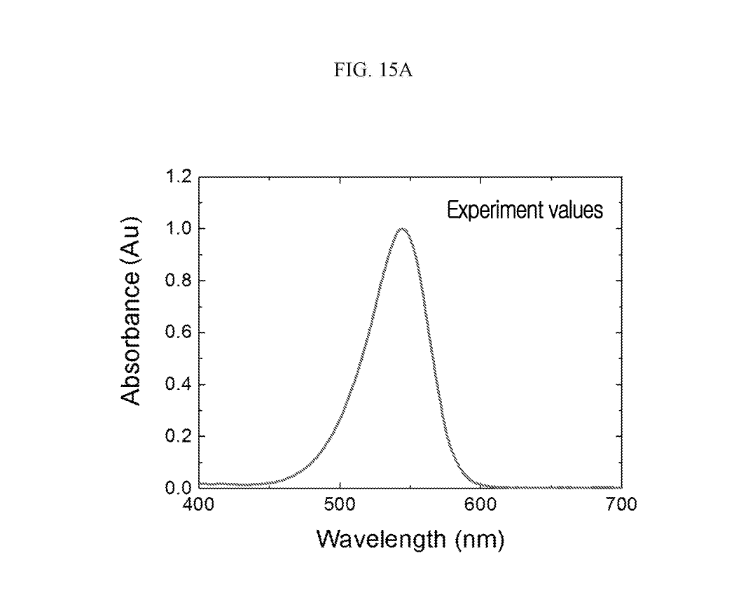

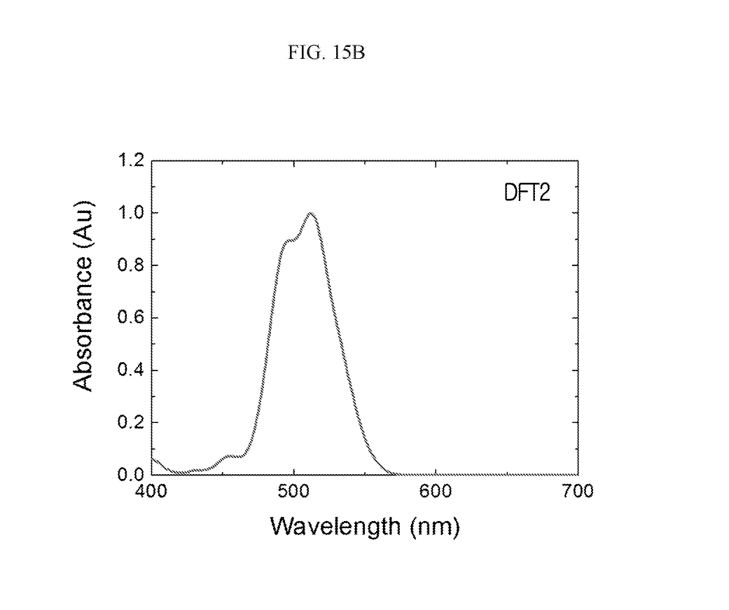

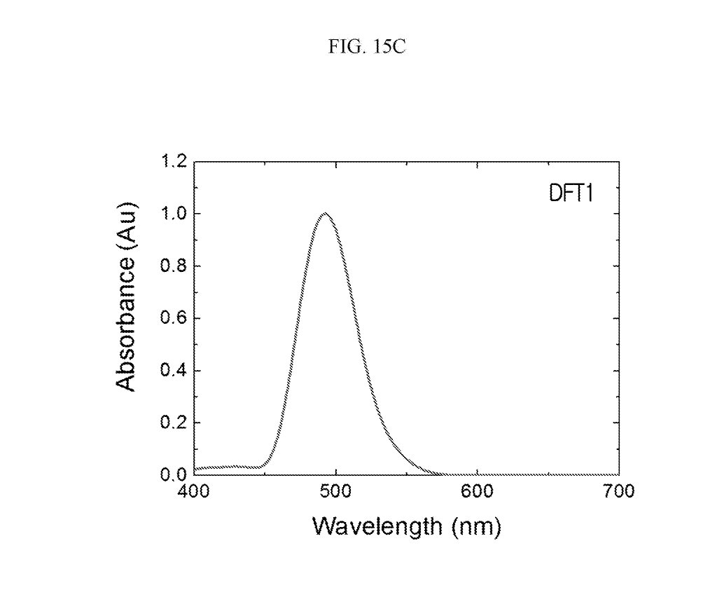

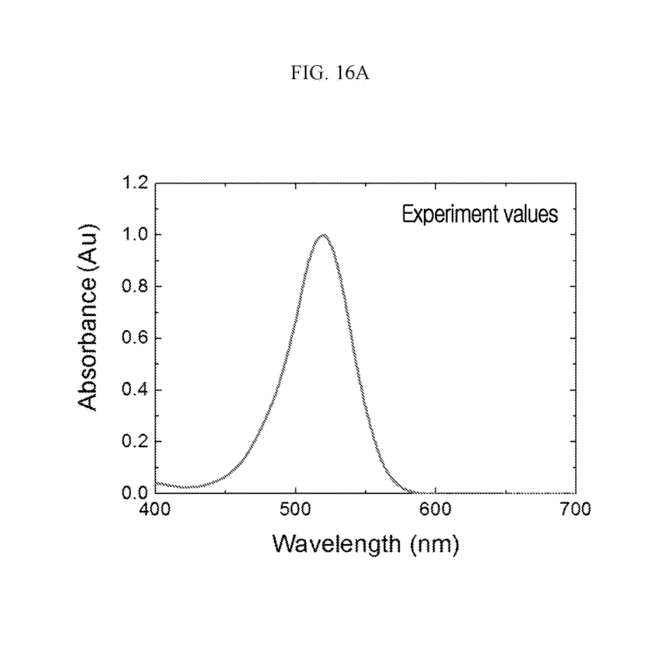

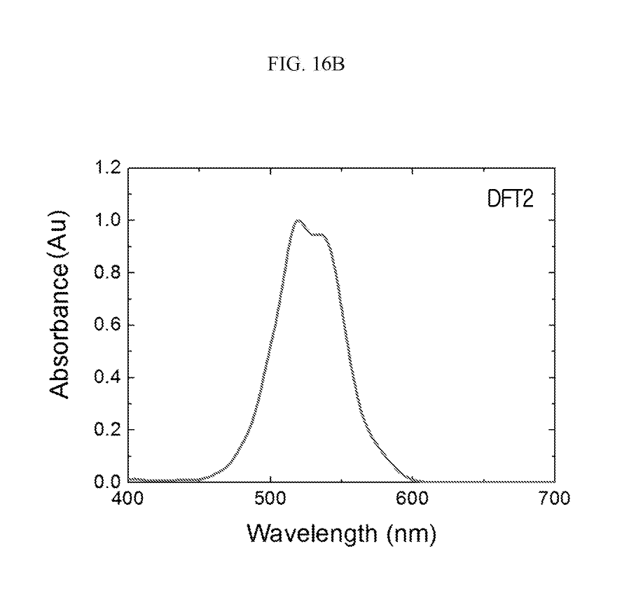

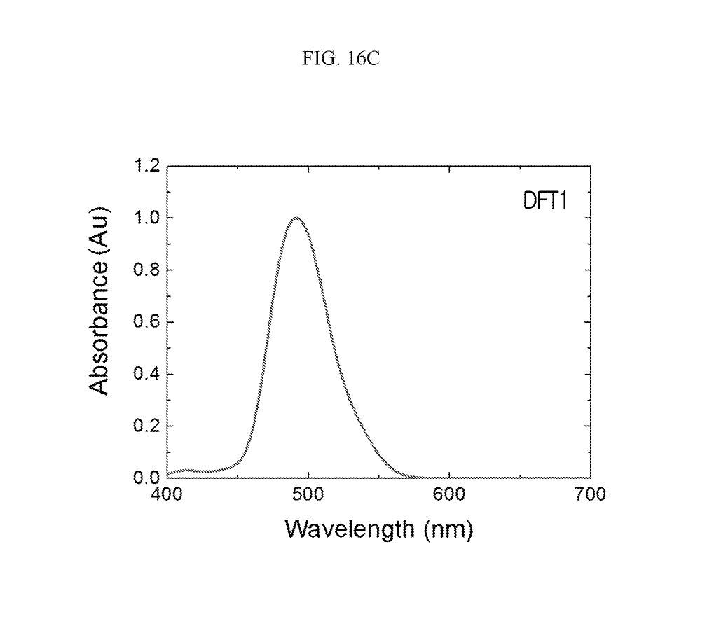

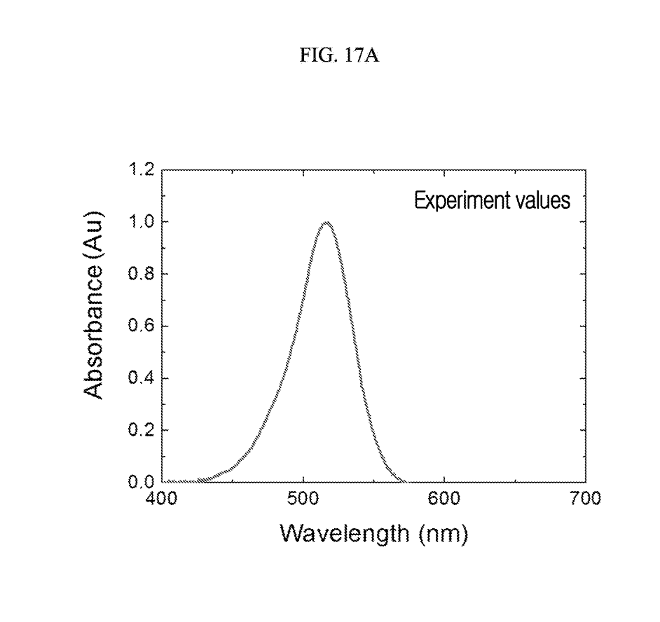

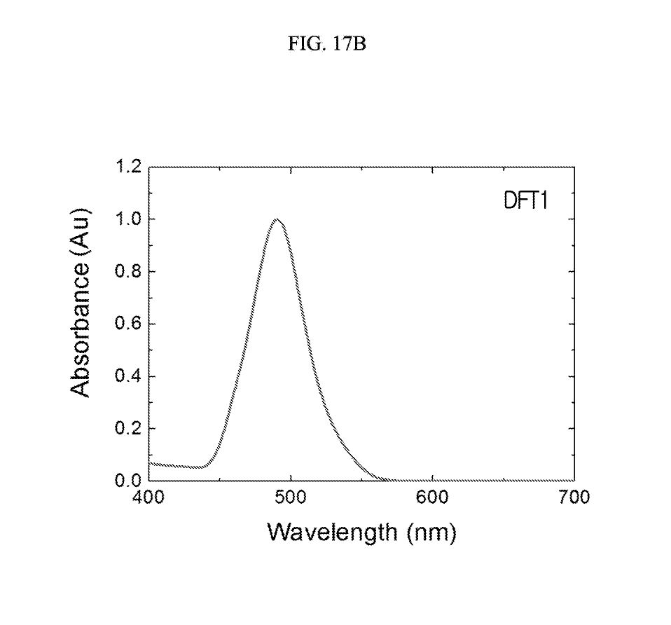

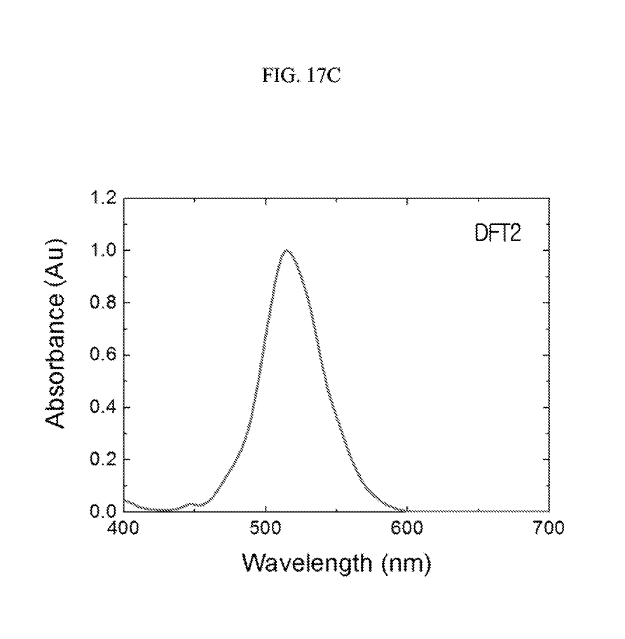

The results are shown in Table 3 and FIGS. 5 to 17.

FIGS. 5 to 17 are graphs, each showing a light absorbance spectrum of Compound 1 and Compounds 2 to 14 obtained from UV-Vis spectroscopy, a light absorption spectrum simulated using DFT1, and a light absorption spectrum simulated using DFT2, respectively.

TABLE 3

| | DFT1 | DFT2 | Designated |
|---|---|---|---|
| | Accuracy (%) | Accuracy (%) | DFT |
| Compound 1 | 85.1 | 61.9 | DFT1 |
| Compound 2 | 89.7 | 65.4 | DFT1 |
| Compound 3 | 99.8 | 72.7 | DFT1 |
| Compound 4 | 98.8 | 71.2 | DFT1 |
| Compound 5 | 92.9 | 48.6 | DFT1 |
| Compound 6 | 85.1 | 68.0 | DFT1 |
| Compound 7 | 55.1 | 84.7 | DFT2 |
| Compound 8 | 8.4 | 83.2 | DFT2 |
| Compound 9 | 33.1 | 86.8 | DFT2 |
| Compound 10 | 77.3 | 98.8 | DFT2 |
| Compound 11 | 93.0 | 95.3 | DFT1/DFT2 |
| Compound 12 | 91.6 | 99.3 | DFT1/DFT2 |
| Compound 13 | 94.4 | 91.4 | DFT1/DFT2 |
| Compound 14 | 98.4 | 98.2 | DFT1/DFT2 |

Referring to Table 3 and FIG. 5 to FIG. 17, the Compounds 1 to 6 have higher accuracy with respect to the experiment values in a case simulated using DFT1 than a case simulated using DFT2; and the Compounds 7 to 10 have higher accuracy with respect to the experiment value in a case simulated using DFT2 than a case simulated using DFT1. On the other hand, the Compounds 11 to 14 all have accuracy of greater than or equal to about 90% when simulated using DFT1 or DFT2, so it is confirmed that either method may be used to provide relatively high accuracy.

Thereby, the Compounds 1 to 6 may be clustered as a first group in which DFT1 is designated as a proper method, and the compounds in the first group may have a full width at half maximum (FWHM) of about 40 nm to about 110 nm when applying DFT1. The Compounds 1 to 6 have a similarity of having an arylamine moiety substituted with at least two aryl groups in the chemical structure. In addition, the Compounds 7 to 10 may be clustered as a second group in which DFT2 is assigned as a proper method, and the compounds in the second group may have a full width at half maximum (FWHM) of about 40 nm to about 110 nm when applying DFT2. The Compounds 11 to 14 may use either DFT1 or DFT2, and these compounds may have a full width at half maximum (FWHM) of about 40 nm to about 110 nm when applying either DFT1 or DFT2.

Accordingly, the test compound having a structural similarity to the compound included in the first group may predict the full width at half maximum (FWHM) of a light absorption spectrum in a visible ray region by applying DFT1, and the test compound having a structural similarity to the compound included in the second group may predict a full width at half maximum (FWHM) of a light absorption spectrum in a visible ray region by applying DFT2. Thus the full width at half maximum (FWHM) may be predicted with relatively high accuracy even not applying all the plurality of density functional theory methods, e.g., DFT1 and/or DFT2, so the proper density functional theory method may be more easily determined.

### Evaluation of Test Compound

The Test 1 compound and the Test 2 compound having the structural similarity to the first group and the Test 3 compound and the Test 4 compound having the structural similarity to the second group are applied with DFT1 and DFT2 and simulated, and then evaluated for a full width at half maximum (FWHM) of the light absorption spectrum in a visible ray region.

Furthermore, the Test 1 to 4 compounds undergo the experimental evaluation in accordance with the same method above to evaluate accuracy of the simulation method.

The results are shown in Table 4 and Table 5.

TABLE 4

| | DFT1 - FWHM (nm) | DFT2 - FWHM (nm) |
|---|---|---|
| Test 1 | 45.1 | 56.4 |
| Test 2 | 69.8 | 54.5 |
| Test 3 | 40.3 | 47.0 |
| Test 4 | 110.0 | 54.4 |

TABLE 5

| | | | DFT2 | |
|---|---|---|---|---|
| | | DFT1 | Error from the | |
| | Experimental | Error from the | experimental | Suitable |
| | FWHM (nm) | experimental values | values | DFT |
| Test 1 | 47 | 1.9 | 9.4 | DFT1 |
| Test 2 | 77 | 7.2 | 22.5 | DFT1 |
| Test 3 | 47 | 6.7 | 0.0 | DFT2 |
| Test 4 | 68 | 42.0 | 13.6 | DFT2 |

Referring to Tables 4 and 5, it is evaluated that, for the Test 1 compound and the Test 2 compound having the structural similarity to the first group, DFT1 is proper as estimated; and it is evaluated that, for the Test 3 compound and the Test 4 compound having the structural similarity to the second group, DFT2 is proper as estimated.

The methods according to the above-described example embodiments may be recorded in non-transitory computer-readable media including program instructions to implement various operations of the above-described example embodiments. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

While this disclosure has been described in connection with what is presently considered to be practical example embodiments, it is to be understood that the inventive concepts are not limited to the disclosed embodiments, but, on the contrary, is intended to cover various modifications and equivalent arrangements included within the spirit and scope of the appended claims.

What is claimed is:

1. A method for predicting a characteristic of a compound, the method comprising:
collecting a first experimental information database for characteristics of a plurality of reference compounds according to a quantum phenomenon;
collecting a simulation database for characteristics of the plurality of reference compounds according to the quantum phenomenon by applying a plurality of density functional theory methods;
comparing the simulation database to the first experimental information database for each reference compound of the plurality of reference compounds to calculate accuracy of the simulation database;
clustering the plurality of reference compounds into a plurality of clusters based on the accuracy of the simulation database and designating a proper density functional theory method for each cluster of the plurality of clusters;
comparing a similarity between a test compound to predict a characteristic according to the quantum phenomenon and the reference compounds included in each cluster of the plurality of clusters;
determining a proper density functional theory method for the test compound according to the similarity; and
conducting a simulation with the test compound according to the determined density functional theory method.

2. The method of claim 1, wherein the collecting a first experimental information database for characteristics of a plurality of reference compounds according to a quantum phenomenon collects the first experimental information database for absorbance according to a wavelength of the plurality of reference compounds.

3. The method of claim 2, wherein the collecting the first experimental information database for absorbance according to a wavelength of the plurality of reference compounds collects the first experimental information database for a full width at half maximum (FWHM) of a light absorption spectrum in a visible ray region.

4. The method of claim 3, wherein the collecting the first experimental information database for a full width at half maximum (FWHM) of a light absorption spectrum in a visible ray region collects the first experimental information database for the full width at half maximum (FWHM) of the light absorption spectrum in the visible ray region by UV-Vis spectroscopy.

5. The method of claim 4, wherein the collecting the first experimental information database for a full width at half maximum (FWHM) of a light absorption spectrum in a visible ray region collects the experimental information for the full width at half maximum (FWHM) of the light absorption spectrum in the visible ray region by preparing the plurality of reference compounds as a solution, the plurality of reference compounds having the full width at half maximum (FWHM) of about 40 nm to about 110 nm.

6. The method of claim 5, wherein
the collecting a simulation database for characteristics of the plurality of reference compounds according to the quantum phenomenon by applying a plurality of density functional theory methods collects the simulation database for characteristics of the plurality of reference compounds according to the quantum phenomenon by applying a first density functional theory method and a second density functional theory method,
the clustering clusters the plurality of reference compounds into a first group of clusters having higher accuracy of the simulation database of the first density functional theory method and a second group of clusters having a higher accuracy of the simulation database of the second density functional theory method,
the clustering clusters the plurality of reference compounds included in the first group of clusters having a full width at half maximum (FWHM) of about 40 nm to about 110 nm when applying the first density functional theory method, and
the clustering clusters the plurality of reference compounds included in the second group of clusters having a full width at half maximum (FWHM) of about 40 nm to about 110 nm when applying the second density functional theory method.

7. The method of claim 6, wherein the clustering predicts characteristics of a compound of the plurality of reference compounds included in the first group of clusters, the compound having an arylamine moiety substituted with at least two aryl groups.

8. The method of claim 1, wherein the comparing the simulation database to the first experimental information database for each reference compound of the plurality of reference compounds calculates the accuracy of the simulation database to be greater than or equal to about 80%.

9. The method of claim 1, wherein the comparing a similarity between a test compound to predict a characteristic according to the quantum phenomenon and the plurality of reference compounds included in each cluster of the plurality of clusters compares a structural similarity of the test compound and the plurality of reference compounds.

10. The method of claim 1, wherein prior to the clustering, further comprising:
clustering the plurality of reference compounds according to a structural similarity after the comparing the simulation database to the first experimental information database for each reference compound of the plurality of reference compounds.

11. The method of claim 1, further comprising:
separating a reference compound that does not cluster from the plurality of reference compounds after the comparing the simulation database to the first experimental information database for each reference compound of the plurality of reference compounds.

12. The method of claim 1, further comprising:
conducting an experiment with the test compound to collect a second experimental information database; and
updating the test compound to the plurality of reference compounds using the second experimental information database.

13. The method of claim 1, wherein the plurality of reference compounds and the test compound are one of p-type and n-type light-absorbing materials.

14. A system of predicting a characteristic of a compound according to the method of claim 1.

15. A system for predicting a characteristic of a compound, the system comprising:
a non-transitory computer readable medium having a computer program logic embodied thereon, the computer program logic configured to,
collect a simulation database for characteristics of a plurality of reference compounds according to a quantum phenomenon by applying an experimental information database for characteristics of the plurality of reference compounds according to the quantum phenomenon and a plurality of density functional theory methods;
calculate accuracy of the simulation database by comparing the experimental information database to the simulation database;
cluster the plurality of reference compounds based on the accuracy of the simulation database and designating a proper density functional theory method for each cluster;
compare a similarity between the test compound and the reference compounds included in each cluster to predict the characteristics according to the quantum phenomenon;
determine a proper density functional theory method for the test compound according to the similarity; and
conduct a simulation of the test compound according to the determined density functional theory method.

16. The system of claim 15, wherein the characteristics according to the quantum phenomenon include a full width at half maximum (FWHM) of a light absorption spectrum in a visible ray region.

17. The system of claim 16, wherein
the plurality of density functional theory methods include a first density functional theory method and a second density functional theory method,
the cluster includes a first group of clusters having higher accuracy of the simulation database of the first density functional theory method and a second group of clusters having higher accuracy of the simulation database of the second density functional theory method,
the plurality of reference compounds included in the first group of clusters have a full width at half maximum (FWHM) of about 40 nm to about 110 nm when applying the first density functional theory method, and
the plurality of reference compounds included in the second group of clusters have a full width at half maximum (FWHM) of about 40 nm to about 110 nm when applying the second density functional theory method.
